(19) United States
(12) Patent Application Publication
(10) Pub. No.: US 2026/0167786 A1
(43) Pub. Date: Jun. 18, 2026

(54) PHA BASED MICROPOROUS ARTICLES AND METHODS OF FORMING THE SAME

(71) Applicant: W. L. Gore & Associates, Inc., Newark, DE (US)

(72) Inventors: Galip O. Erol, Newark, DE (US); Ravi Gupta, Elkton, MD (US); Brian S. Levy, Wilmington, DE (US); Elena Ten, Newark, DE (US)

(21) Appl. No.: 19/122,578

(22) PCT Filed: Oct. 19, 2023
(86) PCT No.: PCT/US2023/077277

§ 371 Date: Apr. 18, 2025

Related U.S. Application Data
(60) Provisional application No. 63/417,687, filed on Oct. 19, 2022.

(51) Int. Cl. C08J 5/18; C08J 7/04

(52) U.S. Cl. CPC C08J 5/18; C08J 7/0427; C08J 2367/04

(57) ABSTRACT

PHA-based microporous and tough articles having node and fibril structures, and processes to create these articles using a below the melt processing approach are provided. A method of forming a porous expanded PHA composite comprising a porous PHA material may include depositing a partially crystallized polyhydroxyalkanoate (PHA) polymer on a substrate at a deposition temperature below a melting temperature of the PHA polymer to form a PHA-substrate composite, and expanding the PHA-substrate composite at a temperature between the glass transition temperature of the PHA polymer and the melting temperature of the PHA polymer.

### FIELD

The present disclosure relates generally to apparatuses, systems, and methods of forming polyhydroxyalkanoate (PHA) based microporous articles. More specifically, the disclosure relates to apparatuses, systems, and methods of forming PHA based microporous articles having nodes and fibrils using a below the melt processing approach.

### BACKGROUND

Polyhydroxybutyrates (PHBs), a sub-family of polyhydroxyalkanoates (PHAs), are biodegradable and biocompatible aliphatic polyesters. PHAs are thermoplastic polymers that are linear polyesters which may be naturally produced by various microorganisms or may be chemically synthesized. PHAs are considered fully circular materials because of their biodegradation pathways in the environment.

PHB materials suffer from poor mechanical properties, and they tend to be stiff and brittle due to their high stereoregularity, crystallinity, and formation of large spherulites. PHB materials also have narrow thermal processing windows since their thermal degradation temperatures are close to their melting point. Additionally, the PHB materials have a low melt strength, which makes melt processing challenging.

Common approaches to alleviate these challenges involve employing low molecular weight PHAs, blends with nucleating agents/other polymers, and using higher-cost PHA copolymers with limited thermal properties to improve processibility as well as their final mechanical properties. However, these approaches inherently limit the highest achievable mechanical properties and any additional materials involved may have a significant impact on the biodegradability, biocompatibility, cost, and potential processing routes; limiting their adaptation in various demanding applications.

PHAs may also be chemotactically synthesized (Westlie et al. Synthetic biodegradable polyhydroxyalkanoates (PHAs): Recent advances and future challenges, Progress in Polymer Science 134 (2022) 101608. Chemo-catalytic synthesis routes enable fine tuning of thermal and mechanical properties of polyesters by manipulating the polymer stereomicrostructure, topology, and pendant group structure. Chemo-catalytic routes towards PHAs offers several advantages such as: (i) precision in synthesis (control of chain length (Mₙ) and Ð, comonomer sequence, and architecture); (ii) tunability in polymer stereomicrostructure (it, st, at, sb-tacticities and R or S stereoconfigurations), molecular catalyst structure (symmetry and chirality; stereoselectivity), and copolymer structure; and (iii) scalability and speed in production (ease in processing and fast reaction kinetics typically associated with catalyzed ring-opening polymerization (ROP) processes) (Westlie et al., supra). Mono- or di-substituting alkyl or aryl groups for the α-hydrogens on the PHA monomer increases the thermal stability of the resulting PHA polymer by suppressing cis-elimination (Zhou et al., Science 380, 64-69 (2023). Examples of these substituted PHA polymers include, but are not limited to, poly(3-hydroxy-2,2-dimethylbuyrate) (P3H(Me)₂B), poly(3-hydroxy-2,2-diethylbuyrate) (P3H(Et)₂B). However, there remains a need to create PHA-based articles that are microporous with sufficient thermal and mechanical properties for many applications.

### SUMMARY

According to one aspect (“Aspect 1”) a method includes depositing a partially crystallized polyhydroxyalkanoate (PHA) polymer on a substrate at a deposition temperature below a melting temperature (Tₘ) of the PHA polymer to form a PHA-substrate composite and expanding the PHA-substrate composite at a temperature between the glass transition temperature (T_{g}) of the PHA polymer and the melting temperature (Tₘ) of the PHA polymer to form a porous expanded PHA composite that includes a porous PHA material having a microstructure including a plurality of nodes and a plurality of fibrils interconnecting the plurality of nodes, where each fibril defines a fibril axis.

According to another aspect (“Aspect 2”) further to Aspect 1, where the fibrils include extended chain crystals (ECC) of the PHA polymer oriented along the fibril axis and where the extended chain crystals of the PHA polymer have a melting temperature that is higher than the Tₘ of the PHA polymer prior to expanding.

According to another aspect (“Aspect 3”) further to Aspect 1 or Aspect 2, where the depositing of the partially crystallized PHA polymer includes dissolving the PHA polymer in a solvent to form a PHA solution, casting the PHA solution on the substrate, and at least partially crystallizing the PHA polymer by partially removing the solvent, adjusting the deposition temperature, or a combination thereof.

According to another aspect (“Aspect 4”) further to any one of Aspects 1 to 3, further including separating the porous PHA material from the porous expanded PHA composite to form a self-supporting porous PHA material.

According to another aspect (“Aspect 5”) further to any one of Aspects 1 to 4, where the self-supporting porous PHA material has a porosity from 25% to 99%.

According to another aspect (“Aspect 6”) further to any one of Aspects 1 to 5, where the self-supporting porous PHA material in the form of a membrane, a tube, a sheet, or a three-dimensional shape.

According to another aspect (“Aspect 7”) further to any one of Aspects 1 to 6, where the self-supporting porous PHA material has a matrix tensile strength of at least 5 MPa in a machine direction (MD) and/or a transverse direction (TD).

According to another aspect (“Aspect 8”) further to any one of Aspects 1 to 7, where a total surface area of the self-supporting porous PHA material per unit mass is from 20 m²/g to 80 m²/g.

According to another aspect (“Aspect 9”) further to any one of Aspects 1 to 8, where the PHA-substrate composite is expanded at a temperature lower than 10° C. below the Tₘ of the PHA polymer.

According to another aspect (“Aspect 10”) further to any one of Aspects 1 to 9, where the PHA-substrate composite is expanded uniaxially, biaxially, or radially.

According to another aspect (“Aspect 11”) further to any one of Aspects 1 to 10, where the PHA-substrate composite is expanded at a rate from 1%/s to 1000%/s.

According to another aspect (“Aspect 12”) further to any one of Aspects 1 to 11, where the PHA-substrate composite has an expansion ratio from 1:1.1 to 1:100.

According to another aspect (“Aspect 13”) further to any one of Aspects 1 to 12, where the PHA polymer includes monomers, homopolymers or copolymers including 3-hydroxybutyrate, 3-hydroxyvalerate, 4-hydroxybutyrate, 3-hydroxyhexanoate, or any combinations thereof.

According to another aspect (“Aspect 14”) further to any one of Aspects 1 to 13, where the PHA polymer is poly(3-hydroxybutryate) (PHB), poly(3-hydroxybutryate-co-3-hydroxyvalerate) (PHBV), poly(4-hydroxybutyrate) (P4HB), poly(3-hydroxybutryate-co-4-hydroxybutyrate) (P3HB4HB), or poly(3-hydroxybutyrate-co-3-hydroxyhexanoate) P(3HB-co-3HHx).

According to another aspect (“Aspect 15”) further to any one of Aspects 1 to 14, further including forming a modified PHA article by processing the porous expanded PHA composite or the self-supporting porous PHA material, where the processing includes coating, imbibing, laminating or any combination thereof, and where the modified PHA article is porous or non-porous.

According to another aspect (“Aspect 16”) further to any one of Aspects 1 to 15, further including densifying the porous expanded PHA composite, the porous self-supporting porous PHA material, or the modified PHA article to form a densified PHA material.

According to another aspect (“Aspect 17”) further to Aspect 16, where the densified PHA material includes a detectable endotherm associated with the presence of the extended chain crystals of the PHA polymer.

According to another aspect (“Aspect 18”) further to Aspect 16 or Aspect 17, where the densifying includes the application of heat, the application of pressure, stretching or any combination thereof.

According to another aspect (“Aspect 19”) further to any one of Aspects 1 to 16, where the PHA polymer further includes at least one porogen prior to deposition on the substate.

According to another aspect (“Aspect 20”) further to Aspect 19, further including removing the porogen before or after expanding the PHA-substrate composite.

According to another aspect (“Aspect 21”) further to any one of Aspects 1 to 16, where the substrate is a deformable substrate.

According to another aspect (“Aspect 22”) further to Aspect 21, where the deformable substrate is an expandable polymer.

According to another aspect (“Aspect 23”) further to Aspect 21 or Aspect 22, where the deformable substrate includes a member selected from a polytetrafluoroethylene (PTFE) tape, a PTFE membrane, a polyolefin tape, a polyolefin membrane, an expanded polyolefin membrane, an ultra-high molecular weight polyethylene (UHMWPE) tape, an UHMWPE membrane, and an expanded UHMWPE membrane.

According to one aspect (“Aspect 24”) a porous polyhydroxyalkanoate (PHA) material formed from a PHA polymer that has a microstructure including a plurality of nodes and a plurality of fibrils interconnecting the plurality of nodes, defining a fibril axis.

According to another aspect (“Aspect 25”) further to Aspect 24, where the fibrils include a plurality of extended chain crystals of the PHA polymer oriented along the fibril axis, where the extended chain crystals of the PHA polymer have a melting temperature higher than the Tₘ of the PHA polymer prior to expansion.

According to another aspect (“Aspect 26”) further to Aspect 24 or Aspect 25, where the PHA polymer has a molecular weight from 30,000 g/mol to 10,000,000 g/mol.

According to another aspect (“Aspect 27”) further to any one of Aspects 24 to 26, where the porous PHA material has a porosity from 25% to 99%.

According to another aspect (“Aspect 28”) further to any one of Aspects 24 to 27, where the porous PHA material is in the form of a membrane, a tube, a sheet, or a three-dimensional shape.

According to another aspect (“Aspect 29”) further to any one of Aspects 24 to 28, where the porous PHA material has a matrix tensile strength of at least 5 MPa in a machine direction (MD) and/or a transverse direction (TD).

According to another aspect (“Aspect 30”) further to any one of Aspects 24 to 29, where a total surface area of the porous PHA material per unit mass is greater than 20 m²/g.

According to another aspect (“Aspect 31”) further to any one of Aspects 24 to 30, where the PHA polymer includes monomers, homopolymers, or copolymers that include 3-hydroxybutyrate, 3-hydroxyvalerate, 4-hydroxybutyrate, 3-hydroxyhexanoate, or any combinations thereof.

According to another aspect (“Aspect 32”) further to any one of Aspects 24 to 31, where the PHA polymer is poly(3-hydroxybutryate) (PHB), poly(3-hydroxybutryate-co-3-hydroxyvalerate) (PHBV), poly(4-hydroxybutyrate) (P4HB), poly(3-hydroxybutryate-co-4-hydroxybutyrate), or poly(3-hydroxybutyrate-co-hydroxyhexanoate) P(HB-co-HHx).

According to another aspect (“Aspect 33”) further to any one of Aspects 24 to 32, where the PHA polymer is blended with an additional polymer selected from polylactic acid (PLA), polybutylene adipate terephthalate (PBAT), polybutylene succinate (PBS), cellulose, polyglycolic acid (PGA), polycaprolactone (PCL), polyvinyl acetate (PVAc), chitin, chitosan, starch, and any combination thereof.

According to one aspect (“Aspect 34”) a composite includes the porous PHA material of any one of Aspects 24-33.

According to another aspect (“Aspect 35”) further to Aspect 34, where the PHA composite is microporous.

According to one aspect (“Aspect 36”) an article including the porous PHA material of any one of Aspects 24-33 or the composite of Aspect 34 and Aspect 35.

According to another aspect (“Aspect 37”) further to Aspect 36, where the article includes a woven or non-woven support substrate.

According to one aspect (“Aspect 38”) a material includes a densified expanded polyhydroxyalkanoate having a detectable endotherm associated with the presence of residual extended chain crystals of the PHA polymer, where the material has a porosity less than 10%.

According to one aspect (“Aspect 39”) a porous polyhydroxyalkanoate (PHA) material is formed from a PHA polymer of Formula I:

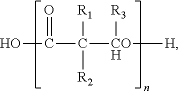

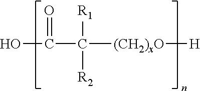

where R₁ and R₂ are independently H or C1 to C6 alkyl or aryl; R₃ is C1 to C4 alkyl; X is 2 to 4; and n=3000 to 100,000; and where the porous PHA material has a fibrillated microstructure that includes a plurality of nodes interconnected by fibrils or only fibrils, and where the fibrils have an orientation defining a fibril axis.

According to another aspect (“Aspect 40”) further to Aspect 39, where the fibrils include a plurality of extended chain crystals of the PHA polymer oriented along the fibril axis, where the extended chain crystals of the PHA polymer have a melting temperature higher than the Tₘ of the PHA polymer prior to expansion.

According to another aspect (“Aspect 41”) further to Aspect 39 or Aspect 40, where the PHA polymer has a molecular weight from 30,000 g/mol to 10,000,000 g/mol.

According to another aspect (“Aspect 42”) further to any one of Aspects 39 to 41, where the porous PHA material has a porosity from 25% to 99%.

According to another aspect (“Aspect 43”) further to any one of Aspects 39 to 42, where the porous PHA material in the form of a membrane, a tube, a sheet, a monofilament, or a three-dimensional shape.

According to another aspect (“Aspect 44”) further to any one of Aspects 39 to 43, where the porous PHA material has a matrix tensile strength of at least 5 MPa in a machine direction (MD) and/or a transverse direction (TD).

According to another aspect (“Aspect 45”) further to any one of Aspects 39 to 44, where a total surface area of the porous PHA material per unit mass is greater than 20 m²/g.

According to another aspect (“Aspect 46”) further to any one of Aspects 39 to 45, where the PHA polymer includes monomers, homopolymers, or copolymers including 3-hydroxybutyrate, 3-hydroxyvalerate, 4-hydroxybutyrate, 3-hydroxyhexanoate, 3-hydroxy-2,2-dimethylbuyrate, 3-hydroxy-2-methylbutyrate, 3-hydroxy-2-ethylbutyrate, 3-hydroxy-2-methyl-2-ethylbutyrate, 3-hydroxy-2,2-diethylbuyrate or any combinations thereof.

According to another aspect (“Aspect 47”) further to any one of Aspects 39 to 46, where the PHA polymer is poly(3-hydroxybutryate) (PHB), poly(3-hydroxybutryate-co-3-hydroxyvalerate) (PHBV), poly(4-hydroxybutyrate) (P4HB), poly(3-hydroxybutryate-co-4-hydroxybutyrate), poly(3-hydroxybutyrate-co-hydroxyhexanoate) P(HB-co-HHx), poly(3-hydroxy-2,2-dimethylbuyrate), poly(3-hydroxy-2-methylbutyrate), poly(3-hydroxy-2-ethylbutyrate, poly(3-hydroxy-2,2-diethylbuyrate) or poly(3-hydroxybutyrate-co-4-hydroxybutyrate).

According to another aspect (“Aspect 48”) further to any one of Aspects 39 to 47, where the PHA polymer is blended with an additional polymer selected from polylactic acid (PLA), polybutylene adipate terephthalate (PBAT), polybutylene succinate (PBS), cellulose, polyglycolic acid (PGA), polycaprolactone (PCL), polyvinyl acetate (PVAc), chitin, chitosan, starch, and any combination thereof.

According to one aspect (“Aspect 49”) a composite includes the porous PHA material of any one of Aspects 39 to 48.

According to another aspect (“Aspect 50”) further to Aspect 49, where the PHA composite is microporous.

According to one aspect (“Aspect 51”) an article includes the porous PHA material of any one of Aspects 39 to 48 or the composite of Aspect 49 or Aspect 50.

According to another aspect (“Aspect 52”) further to Aspect 51, in the form of a membrane, a tube, a sheet, a monofilament article, or a three-dimensional shape.

According to another aspect (“Aspect 53”) further to Aspect 52, where the monofilament article is a dental floss, a medical suture, or a fishing line.

According to another aspect (“Aspect 54”) further to Aspect 51, where the article includes a woven or non-woven support substrate.

According to one aspect (“Aspect 55”) a woven or knitted fabric includes the porous PHA of any one of Aspects 39 to 48.

According to one aspect (“Aspect 56”) a wearable garment includes the woven or knitted fabric of Aspect 55.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure. The figures are not necessarily drawn to scale but may be exaggerated to illustrate various aspects of the present disclosure, and in that regard, the figures should not be construed as limiting.

FIGS. 1A and 1B are scanning electron microscope (SEM) micrographs of a porous poly(3-hydroxybutyrate) membrane made in Example 11 at two different magnifications in accordance with embodiments disclosed herein;

FIGS. 2A and 2B are scanning electron microscope (SEM) micrographs of a porous poly(3-hydroxybutyrate) membrane made in Example 12 at two different magnifications in accordance with embodiments disclosed herein;

FIGS. 3A and 3B are scanning electron microscope (SEM) micrographs of a porous poly(3-hydroxybutyrate) membrane made in Example 14 at two different magnifications in accordance with embodiments disclosed herein;

FIG. 4 is graphical image of the differential scanning calorimetry analysis (DSC) of the cast P3HB film and the resulting biaxially expanded P3HB membrane as described in Example 14 in accordance with embodiments disclosed herein;

FIGS. 5A and 5B are scanning electron microscope (SEM) micrographs of a porous poly(3-hydroxybutyrate) membrane made in Example 15 at two different magnifications in accordance with embodiments disclosed herein;

FIGS. 6A and 6B are scanning electron microscope (SEM) micrographs of a porous poly(3-hydroxybutyrate) membrane made in Example 16 at two different magnifications in accordance with embodiments disclosed herein;

FIGS. 7A and 7B are scanning electron microscope (SEM) micrographs of a porous poly(3-hydroxybutyrate-co-3-hydroxyvalarate) membrane described in Example 17 at two different magnifications in accordance with embodiments disclosed herein;

FIG. 8 is graphical illustration of the differential scanning calorimetry analysis (DSC) of the cast PHBV film and the resulting biaxially expanded PHBV membrane described in Example 17 in accordance with embodiments disclosed herein;

FIG. 9 is a scanning electron microscope (SEM) micrograph of a porous poly(3-hydroxybutyrate-co-3-hydroxyvalarate) membrane described in Example 19 in accordance with embodiments disclosed herein;

FIG. 10 is a scanning electron microscope (SEM) micrograph of a porous poly(3-hydroxybutyrate-co-3-hydroxyhexanoate) membrane described in Example 20 in accordance with embodiments disclosed herein; and

FIGS. 11A and 11B are scanning electron microscope (SEM) micrographs of a porous poly(3-hydroxybutyrate)/polyethylene composite membrane described in Example 22 in accordance with embodiments disclosed herein. FIG. 11A is a top view of the composite illustrating the porous P3HB layer having a microstructure of nodes and fibrils. FIG. 11B is a cross-sectional view of the porous P3HB/PE composite illustrating the porous P3HB layer and the porous polyethylene layer.

### DETAILED DESCRIPTION

### Definitions and Terminology

This disclosure is not meant to be read in a restrictive manner. For example, the terminology used in the application should be read broadly in the context of the meaning those in the field would attribute such terminology. It is to be appreciated that the terms “melt temperature”, “melting temperature”, and “melt point” may be used interchangeably herein.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

“Polyhydroxyalkanoates (PHAs)”, as used herein, are linear biodegradable polyesters that may be produced by various microorganisms or may be chemocatically synthesized (Westlie et al., supra).

In some embodiments, the PHA polymers suitable to prepare the present porous articles include those shown in Formula I and Formula II:

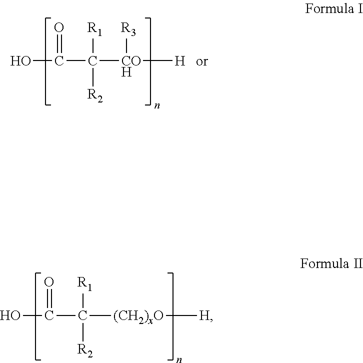

where R₁ and R₂ are independently H or C1 to C6 alkyl or aryl;
   R₃ is C1 to C7 alkyl or aryl;
   X is 2 to 4; and

$$n = 3000 to 100 , 0.$$

In some embodiments, R₁ and R₂ are both hydrogen. In some embodiments, at least one of R₁ and R₂ are C1 to C6 alkyl or aryl. In some embodiments, both R₁ and R₂ are C₁ to C₆ alkyl or aryl. In some embodiments, both R₁ and R₂ are C₁ to C₆ alkyl.

The PHA polymers used to prepare the present microporous PHA articles having a fibrillated microstructure (i.e. nodes interconnected by fibrils or essentially only fibrils) may be PHA homopolymers, PHA copolymers, or PHA terpolymers.

PHAs are classified based on the carbon numbers in their monomeric units. Some of the short-chain-length PHAs consisting of 3-5 carbon monomers include poly(3-hydroxybutyrate), poly(3-hydroxybutyrate-co-3-hydroxyvalerate), poly(4-hydroxybutyrate), and poly(3-hydroxybutyrate-co-4-hydroxybutyrate). Medium-chain-length PHAs with 6-14 carbon monomers include poly(3-hydroxybutyrate-co-3-hydroxyhexanoate), poly(3-hydroxybutyrate-co-3-hydroxyoctanoate), and poly(3-hydroxybutyrate-co-3-hydroxydecanoate) while long-chain-length PHAs are comprised of at least 15 carbon monomers (Tan et al., Polymers 2014, 6: 706-754).

PHAs may include mono- or di-substituting alkyl or aryl groups for the α-hydrogens on the PHA monomer to increase the thermal stability of the resulting PHA polymer by suppressing cis-elimination (Zhou et al., Science 380, 64-69 (2023). Examples of these substituted PHA polymers include, but are not limited to, poly(3-hydroxy-2,2-dimethylbuyrate) (P3H(Me)₂B), and poly(3-hydroxy-2,2-diethylbuyrate) (P3H(Et)₂B).

Many linear PHA homopolymers and copolymers are semi-crystalline. The relative degree of crystallinity can be determined using a variety of well-known techniques including, but not limited to, density measurements, differential scanning calorimetry, X-ray diffraction, infrared spectroscopy, and nuclear magnetic resonance (NMR).

The present method creates a node and fibril microstructure with fibrils containing oriented extended molecular chains of the PHA polymer along the fibril's longitudinal axis. The oriented chains may be in the form of extended-chain crystals (ECC). “Extended chain crystal”, as used herein, refers to a crystalline form where linear PHA polymer chains are oriented in a highly extended conformation. An extended-chain crystal is the most thermodynamically stable form a polymer material. As such, extended chain crystals of the PHA polymer will have a melting temperature higher than the melting temperature of the PHA polymer prior to expanding. The presence of extended chain crystals may be determined using differential scanning calorimetry (DSC).

“Partial crystallization”, as used herein, describes semi-crystalline polymers having a degree of crystallinity ranging from about 5% to less than 90%.

Examples of various PHAs and their associated melting temperatures and glass transition temperatures are provided below in Table 1.

TABLE 1
Melting Temperatures (Tₘ) and Glass Transition Temperatures
(T_{g}) of Various Polyhydroxyalkanoates

| | | Glass | |
|---|---|---|---|
| | Melting | transition | |
| | temperature | temperature | |
| Polyhydroxyalkanoate | Tₘ (° C.) | T_{g} (° C.) | Reference |
| Poly (3-hydroxybutyrate) | 180 | 4 | [1] |
| (P3HB) | | | |
| Poly (3-hydroxybutyrate-co-3- | 83 | −13 | [1] |
| hydroxyvalerate) | | | |
| [71 mol % 3-hydroxyvalerate] | | | |
| Poly (4-hydroxybutyrate) | 53 | −48 | [1] |
| Poly (3-hydroxybutyrate-co-4- | 124.48 | −4.3 | [3] |
| hydroxybutyrate) | | | |
| [12 mol % 4-hydroxybutyrate] | | | |
| Poly (3-hydroxybutyrate-co-3- | 138.3 | 0.46 | [2] |
| hydroxyhexanoate) | | | |
| Poly (3-hydroxybutyrate-co-3- | 102.57 | −1.52 | [3] |
| hydroxyhexanoate) | | | |
| [12 mol % 3- | | | |
| hydroxyhexanoate] | | | |
| Poly (3-hydroxybutyrate-co-4- | 135 | 0.8 | [4] |
| hydroxybutyrate) | | | |
| [6 mol % 4-hydroxybutyrate] | | | |
| Isotactic Poly (3-hydroxy-2,2- | 243 | | [5] |
| dimethylbutyrate) | | | |
| Atactic Poly (3-hydroxy-2,2- | 176 | 33 | [5] |
| dimethylbutyrate) | | | |
| Poly (3-hydroxy-2,2- | 149 | 34 | [5] |
| diethylbutyrate) | | | |

[1] Sudesh, K., Abe, H., Doi, Y., (2000), Progress in Polymer Science, 25(10): 1503-1555.
[2] Martinez, J. I., Verdu, I., Fenollar, O., Sanchez-Nacher, L., Balart, R. and Quiles-Carrillo, (2020), Polymers, 12, 1118.
[3] Luo, L., Wei, X. and Chen, GQ., (2009), Journal of Biomaterials Science, 20, 1537-1553.
[4] Hori, Y., Yamaguchi, A. and Hagiwara, T., (1995), Polymer, 36, 24, 4703-4705.
[5] Zhou, L., Zhang, Z., Shi, C., Scoti, M., Barange, D K., Gowda, R R. And Chen, E Y X., (2023), Science, 380, 64-69.

### DESCRIPTION OF VARIOUS EMBODIMENTS

The present disclosure relates to PHA-based microporous and tough articles having node and fibril structures and processes to create these articles using a below the melt processing approach. The PHA-based microporous article processed through a below the melt approach has improved processibility and mechanical properties, and helps maintain PHA polymers as a bioderived sustainable material option.

In some embodiments, a PHA-based microporous intermediate may be created through solvent induced phase inversion and thermally induced phase inversion, where all the processes are carried out below the melting temperature of the selected PHA. The intermediates may be created by blending or dissolving raw PHA homopolymers and/or copolymers with solvents and/or plasticizers.

In some embodiments, the intermediates may then be stretched or expanded above the glass transition temperature and below the melting temperature of the selected PHA. Stretching may be carried out uniaxially, biaxially, and/or sequentially. The final stretched articles have a node and fibril microstructure with fibrils containing oriented molecular chains along the fibrils' longitudinal axis, resulting in improved mechanical properties. PHAs are surface degrading materials. The degradation rate of the final articles may also be controlled through their properties by varying processing parameters of stretching and/or the initial properties of PHAs. For example, the degradation rate may be controlled through the PHA's surface area, molecular weight, crystallinity, etc.

In some embodiments, a method of forming a porous expanded PHA composite includes depositing a partially crystallized PHA polymer on a substrate at a deposition temperature below a melting temperature of the PHA polymer to form a PHA substrate composite. Depositing the PHA polymer may include dissolving the PHA polymer in a solvent to form a PHA solution, casting the PHA solution on the substrate, and at least partially crystallizing the PHA polymer by partially removing the solvent, adjusting the deposition temperature, or a combination thereof.

In some embodiments, the method may also include expanding the PHA substrate composite at a temperature between the glass transition temperature of the PHA polymer and the melting temperature of the PHA polymer. The formed PHA composite may include a porous PHA material with a microstructure having a plurality of nodes and a plurality of fibrils interconnecting the plurality of nodes, defining a fibril axis. The fibrils of the porous expanded PHA composite may include extended chain crystals (ECC) of the PHA polymer oriented along the fibril axis. The extended chain crystals of the PHA polymer may have a melting temperature higher than the melting temperature of the PHA polymer prior to expanding. The PHA composite may be expanded uniaxially, biaxially, or radially.

The semi-crystalline PHA polymer may include combinations of short-, medium-, and long-chain PHA monomers, homopolymers or copolymers. In some embodiments, the PHA polymer may include monomers, homopolymers or copolymers including 3-hydroxybutyrate, 3-hydroxyvalerate, 4-hydroxybutyrate, 3-hydroxyhexanoate, or any combinations thereof. In some embodiments, the PHA copolymers may include monomers such as 3-hydroxyhexanoate, 3-hydroxyoctanoate, 3-hydroxydecanoate, and combinations there. In some embodiments, the PHA polymer may be poly(3-hydroxybutryate) (PHB), poly(3-hydroxybutryate-co-3-hydroxyvalerate) (PHBV), poly(4-hydroxybutyrate) (P4HB), poly(3-hydroxybutryate-co-4-hydroxybutyrate) (P3HB4HB), or poly(3-hydroxybutyrate-co-3-hydroxyhexanoate) P(3HB-co-3HHx). In some embodiments the PHA polymer may be poly(3-hydroxybutyrate-co-3-hydroxyoctanoate or poly(3-hydroxybutyrate-co-3-hydroxydecanoate).

In some embodiments, the PHA polymer may include at least one porogen prior to deposition on the substrate. In some instances, the porogen may be removed before expanding the PHA substrate composite. In some instances, the porogen may be removed after expanding the PHA substrate composite.

The substrate may be deformable. In some embodiments, the substrate may be an expandable polymer different from the PHA polymer. In some embodiments, the substrate may include a member selected from a polytetrafluoroethylene (PTFE) tape, a PTFE membrane, a polyolefin tape, a polyolefin membrane, an expanded polyolefin membrane, an ultra-high molecular weight polyethylene (UHMWPE) tape, an UHMWPE membrane, and an expanded UHMWPE membrane.

Expanding the PHA substrate composite may be conducted at a temperature lower than about 5° C. to 15° C. below the melting temperature of the PHA polymer, or lower than about 6° C. to 14° C., or lower than about 7° C. to 13° C., or lower than about 8° C. to 12° C., or lower than about 9° C. to 11° C. below the melting temperature of the PHA polymer, or any temperature encompassed by the foregoing ranges. In some embodiments, the PHA substrate composite may be expanded at a temperature of lower than about 10° C. below the melting temperature of the PHA polymer.

Expanding the PHA substrate may be at a rate of from about 1%/s to about 1000%/s, or from about 2%/s to about 950%/s, or from about 3%/s to about 900%/s, or from about 4%/s to about 850%/s, or from about 5%/s to about 800%/s, or from about 6%/s to about 750%/s, or from about 7%/s to about 700%/s, or from about 8%/s to about 650%/s, or from about 9%/s to about 600%/s, or from about 10%/s to about 550%/s, or from about 15%/s to about 500%/s, or from about 20%/s to about 450%/s, or from about 25%/s to about 400%/s, or from about 30%/s to about 350%/s, or from about 35%/s to about 300%/s, or from about 40%/s to about 250%/s, or from about 45%/s to about 200%/s, or from about 50%/s to about 150%/s, or any rate encompassed by the foregoing ranges.

The PHA substrate composite may have an expansion ratio of from about 1:1.1 to about 1:100, or from about 1:1.2 to about 1:95, or from about 1:1.3 to about 1:90, or from about 1:1.4 to about 1:85, or from about 1:1.5 to about 1:80, or from about 1:1.6 to about 1:75, or from about 1:1.7 to about 1:70, or from about 1:1.8 to about 1:65, or from about 1:1.9 to about 1:60, or from about 1:2 to about 1:55, or from about 1:3 to about 1:50, or from about 1:4 to about 1:45, or from about 1:5 to about 1:40, or from about 1:6 to about 1:35, or from about 1:7 to about 1:30, or from about 1:8 to about 1:25, or from about 1:9 to about 1:20, or from about 1:10 to about 1:15, or any expansion ratio encompassed by the foregoing ranges.

In some embodiments, the method of forming a porous expanded PHA composite may further include separating the porous PHA material from the porous expanded PHA composite to form a self-supporting porous PHA material. The self-supporting porous PHA material may be in the form of a membrane, a tube, a sheet, or a three-dimensional shape.

The self-supporting porous PHA material may have a porosity from about 25% to about 99%, or from about 30% to about 98.5%, or from about 35% to about 98%, or from about 40% to about 97.5%, or from about 45% to about 97%, or from about 50% to about 96.5%, or from about 55% to about 96%, or from about 60% to about 95.5%, or from about 65% to about 95%, or from about 66% to about 94.5%, or from about 67% to about 94%, or any porosity encompassed by the foregoing ranges.

The self-supporting porous PHA material may have a matrix tensile strength at least 5 MPa in a machine direction (MD) and/or a transverse direction (TD). In some embodiments, the self-supporting porous PHA material may have a matrix tensile strength of at least 10 MPa, or at least 15 MPa, or at least 20 MPa, or at least 25 MPa in MD or TD.

In some embodiments, the total surface area of the self-supporting porous PHA material per unit mass (Specific Surface Area) may be from about 1 m²/g to about 150 m²/g, or from about 1 m²/g to about 100 m²/g, or from about 5 m²/g to about 95 m²/g, or from about 10 m²/g to about 90 m²/g, or from about 15 m²/g to about 85 m²/g, or from about 20 m²/g to about 80 m²/g, or from about 25 m²/g to about 75 m²/g, or from about 26 m²/g to about 74 m²/g, or from about 27 m²/g to about 73 m²/g, or any Specific Surface Area encompassed by the foregoing ranges.

In some embodiments, the method of forming a porous expanded PHA composite may further include forming a modified PHA article by processing the porous expanded PHA composite or the self-supporting porous PHA material. The processing may include coating, imbibing, laminating or any combination thereof. In some instances, the modified PHA article may be porous. In some instances, the modified PHA article may be non-porous.

In some embodiments, the porous expanded PHA composite, the porous self-supporting porous PHA material or the modified PHA article may be densified to form a densified PHA material. The densifying (densification) may include application of heat, application of pressure, stretching or any combination thereof. The densified PHA material may include a detectable endotherm associated with the presence of the extended chain crystals of the PHA polymer.

In some embodiments, a porous polyhydroxyalkanoate (PHA) material having a plurality of nodes and a plurality of fibrils interconnecting the plurality of nodes may be formed from a PHA polymer. The plurality of fibrils may define a fibril axis and include a plurality of extended chain crystals of the PHA polymer oriented along the fibril axis. Prior to expanding the PHA polymer, the extended chain crystals of the PHA polymer may have a melting temperature higher than the melting temperature of the PHA polymer. The porous PHA material may be in the form of a membrane, a tube, a sheet, a monofilament, or a three-dimensional shape.

The PHA polymer may include monomers, homopolymers, or copolymers including 3-hydroxybutyrate, 3-hydroxyvalerate, 4-hydroxybutyrate, 3-hydroxyhexanoate, or any combinations thereof. In some embodiments, the PHA polymer may be poly(3-hydroxybutryate) (PHB), poly(3-hydroxybutryate-co-3-hydroxyvalerate) (PHBV), poly(4-hydroxybutyrate) (P4HB), poly(3-hydroxybutryate-co-4-hydroxybutyrate) (P3HB4HB), or poly(3-hydroxybutyrate-co-3-hydroxyhexanoate) P(3HB-co-3HHx).

The PHA polymer may have a molecular weight from about 30,000 g/mol to about 10,000,000 g/mol, or from about 30,000 g/mol to about 10,000,000 g/mol, or from about 40,000 g/mol to about 9,000,000 g/mol, or from about 50,000 g/mol to about 8,000,000 g/mol, or from about 60,000 g/mol to about 7,000,000 g/mol, or from about 70,000 g/mol to about 6,000,000 g/mol, or from about 80,000 g/mol to about 5,000,000 g/mol, or from about 90,000 g/mol to about 4,000,000 g/mol, or from about 100,000 g/mol to about 3,000,000 g/mol, or from about 110,000 g/mol to about 2,000,000 g/mol, or from about 120,000 g/mol to about 1,000,000 g/mol, or from about 130,000 g/mol to about 900,000 g/mol, or any molecular weight encompassed by the foregoing ranges.

In some embodiments, the PHA polymer may be blended with an additional polymer selected from polylactic acid (PLA), polybutylene adipate terephthalate (PBAT), polybutylene succinate (PBS), cellulose, polyglycolic acid (PGA), polycaprolactone (PCL), polyvinyl acetate (PVAc), chitin, chitosan, starch, and any combination thereof.

In some embodiments, the porous PHA material may have a porosity of from about 25% to 99%, or from about 30% to about 98.5%, or from about 35% to about 98%, or from about 40% to about 97.5%, or from about 45% to about 97%, or from about 50% to about 96.5%, or from about 55% to about 96%, or from about 60% to about 95.5%, or from about 65% to about 95%, or from about 66% to about 94.5%, or from about 67% to about 94%, or any porosity encompassed by the foregoing ranges.

In some embodiments, the porous PHA material may have a matrix tensile strength of at least 5 MPa in a machine direction (MD) and/or a transverse direction (TD). In some embodiments, the self-supporting porous PHA material may have a matrix tensile strength of at least 10 MPa, or at least 15 MPa, or at least 20 MPa, or at least 25 MPa in MD or TD.

In some embodiments, the porous PHA material may have a total surface area per unit mass (Specific Surface Area) from about 1 m²/g to about 150 m²/g, or from about 1 m²/g to about 100 m²/g, or from about 5 m²/g to about 95 m²/g, or from about 10 m²/g to about 90 m²/g, or from about 15 m²/g to about 85 m²/g, or from about 20 m²/g to about 80 m²/g, or from about 25 m²/g to about 75 m²/g, or from about 26 m²/g to about 74 m²/g, or from about 27 m²/g to about 73 m²/g. In an exemplary embodiment, a total surface area of the porous PHA material per unit mass (Specific Surface Area) is greater than about 20 m²/g, or any Specific Surface Area encompassed by the foregoing ranges.

In some embodiments, the porous PHA material may have a mass per area from about 0.1 g/m² to about 100 g/m², or from about 0.1 g/m² to about 50 g/m², or from about 0.5 g/m² to about 50 g/m², or from about 0.5 g/m² to about 10 g/m², or from about 0.7 g/m² to about 9 g/m², from about 0.9 g/m² to about 8 g/m², from about 1 g/m² to about 7 g/m², from about 1.1 g/m² to about 6 g/m², from about 1.2 g/m² to about 5 g/m², from about 1.5 g/m² to about 4.5 g/m², or any mass per area encompassed by the foregoing ranges.

In some embodiments, the porous PHA material may be in the form of a membrane having a thickness of from about 5 μm to about 500 μm, or a thickness from about 5 μm to about 100 μm, or from about 6 μm to about 90 μm, from about 7 μm to about 80 μm, from about 8 μm to about 70 μm, from about 9 μm to about 65 μm, from about 10 μm to about 60 μm, from about 11 μm to about 55 μm, or any thickness encompassed by the foregoing ranges.

In some embodiments, the porous PHA material may have an ATEQ airflow rate of from about 0.1 L/hr to about 1000 L/hr, or from about 0.1 L/hr to about 400 L/hr, or from about 0.5 L/hr to about 390 L/hr, or from about 1 L/hr to about 380 L/hr, or from about 1.5 L/hr to about 370 L/hr, or from about 2 L/hr to about 360 L/hr, or from about 2.5 L/hr to about 350 L/hr, or from about 2.9 L/hr to about 340 L/hr, or from about 3 L/hr to about 330 L/hr, or any ATEQ airflow rate encompassed by the foregoing ranges.

In some embodiments, the porous PHA material may a Water Entry Pressure (WEP) of about 7 kPa.

In some embodiments, a composite may include the porous PHA material as described herein. The composite may be microporous. In some embodiments, an article may include the porous PHA material or the composite including the porous PHA material. The article may include a woven or non-woven support substrate.

In some embodiments, a material including densified expanded polyhydroxyalkanoate having a detectable endotherm associated with the presence of residual extended chain crystals of the PHA polymer may have a porosity of less than 10%.

In some embodiments, the PHA-based microporous article having a fibrillated microstructure is in the form of a microporous monofilament. The monofilament may be used to make woven and knitted articles, fabrics, medical sutures, fishing line, dental floss/tape, and the like. The PHA monofilament may include a variety of further modifications to introduce additional texture or coarseness (for example, twisting, folding, knotting, embossing, formation of ribbed structures, incorporation of abrasive fillers, and combinations thereof), especially for applications such as medical sutures, dental floss/tape, and the like. In one embodiment, the PHA monofilament may be formed by cutting/slitting a PHA membrane into thin strips of an appropriate size for the desired application using the general methodology described in International Pat. Appl. Pub. No. WO2022/103783 A1 to Minor, R. (describing the preparation of porous ultra-high molecular weight polyethylene (UHMWPE) dental floss). In various embodiments, the PHA strips may be stacked and subjected to further mechanical processing modifications such as twisting, folding, knotting, embossing, calendaring, additional stretching or expansion, and various combinations thereof to obtain the desired properties for the target application. In some embodiments, these further mechanical processing modifications steps may be conducted above or below the melt of the PHA polymer. In further embodiments, the further mechanical processing modifications are conducted below the melt of the PHA polymer.

In some embodiments, the porous PHA monofilament further includes functional additives such as particulate fillers, flavorants, anticaries agents, colorants, coatings (waxes, silicones, etc.), radiopaque materials, and the like. Introduction of structural features and functional additives/coatings for dental floss/tape applications to the present PHA monofilaments having a fibrillated microstructure may follow the general methodology used to prepare dental floss/tapes based on non-PHA polymers (for example, see U.S. Patent Appl. Pub. No. 2011/0214683 A1 to Hardesty and U.S. Pat. No. 8,522,796 B2 to Ochs; U.S. Pat. No. 7,854,235 B2 to Blanchard et al., U.S. Pat. No. 8,048,111 B2 to Lutz et al., U.S. Pat. No. 7,174,903 B2 to Longoni, E., U.S. Pat. No. 7,060,354 B2 to Baillie et al., and U.S. Pat. No. 6,289,904 B1 Suhonen et al.).

In further embodiments, the porous PHA monofilament is used to make a fabric. The fabric may include one or more porous PHA monofilament yarns, porous PHA multifilament yarns, or a combination thereof. Such yarns may be formed from the above-described microporous PHA monofilament as well as other materials, such as wool, cotton, silk, flax, hemp, hair from various animals, angora, sisal, ramie, acrylic, polyester, polyamide, polyaramid, polyurethane, acetate, rayon, polybenzimidazole, polybenzoxazole, lyocell, modacrylic, polyvinylidene chloride, carbon, glass, cellulose, cellulose acetate, cellulose esters, elastic fibers, or any combination thereof.

### Test Methods

### Average Thickness Measurements

Thickness was measured by placing the sample between the two plates of a Mitutoyo contact thickness gauge (Mitutoyo America Corporation, Aurora, IL). The average of three measurements was reported and used in the Percent Porosity Calculation below.

### Percent Porosity Calculation

Percent porosity of the membranes was calculated by using 1.2 g/cm³ as the full density of the samples. The samples were die cut with a 25 mm circular die. Each sample was weighed using an electronic balance (Mettler Toledo, Columbus, OH). The density of the sample can be calculated using the following formula:

$$ρ = \frac{m}{A * t}$$

$$where ρ = density ( g / {cm}^{3} ) , m = mass ( g ) ,$$

$$A = area of the circular die ( {cm}^{2} ) , and t = thickness ( cm ) .$$

The average of three measurements was reported.

### Differential Scanning Calorimetry (DSC)

DSC data were collected using a TA Instruments Discovery DSC (TA Instruments—Waters LLC, New Castle, DE) between −50° C. and 200° C. using a heating rate of 10° C. /min. The membrane samples were prepared by punching 4 mm disks and placing them in a pan with the lid crimped to sandwich the membrane disk between the pan and lid.

### Scanning Electron Micrographs (SEM)

The SEM samples were imaged at 1.0 to 10 kV using a Hitachi FlexSEM 1000 II (Hitachi High-Tech America, Inc., Schaumburg, IL).

### Tensile Testing

Matrix tensile strength (MTS) was measured by measuring stress response to a constant uniaxial displacement rate using an Axial Test on a Dynamic Mechanical Analyzer (DMA) (Model: RSA-G2 manufactured by TA Instruments—Waters LLC, New Castle, DE, USA). Rectangular-shaped specimens of the samples were die cut with a width of a 4.7 mm. The DMA was equipped with film/fiber tension clamps. The clamps gap was referenced at the same test conditions of room temperature (about 22° C.). A prepared specimen was mounted on the DMA clamps with a gauge length at 10 mm. The axial test consists of applying a constant displacement rate of 0.1 mm/s while measuring the transient axial force.

Matrix tensile strength was calculated using the following equation: MTS=(maximum stress/cross-sectional area)*(true density/bulk density of the sample)

### Air Flow Measurement

ATEQ® Airflow is a test method for measuring volumetric flow rates of air through a sample. Each sample was clamped between two plates with a #210 or equivalent O-ring on each plate with an open hole in between the O-ring in a manner that creates a sealed area of 2.99 cm² across the flow pathway. The hole in the flow path on the downstream side had a grid support structure across it. An ATEQ® (ATEQ Corp., Livonia, Mich.) Premier D Compact Flow Tester or equivalent was used to measure airflow rate (L/hr) through each sample by challenging it with a differential air pressure of 1.2 kPa (12 mbar) across the sample. The reported results are the average of three measurements.

### Specific Surface Area Measurements

Brunauer-Emmett-Teller (BET) surface area analysis using Quantachrome NOVAtouch LX4 (Anton Paar GmbH, Germany) was employed to measure the specific surface area of the samples.

### Water Entry Pressure (WEP) Measurement

Water entry pressure provides a test method for water intrusion through membranes. A test sample is clamped between a pair of testing plates. The lower plate has the ability to pressurize a section of the sample with water. A piece of pH paper is placed on top of the sample between the plate on the non-pressurized side as an indicator of evidence for water entry. The sample is then pressurized in small increments, waiting 10 seconds after each pressure change until a color change in the pH paper indicates the first sign of water entry. The water pressure at breakthrough or entry is recorded as the Water Entry Pressure. The test results are taken from the center of test sample to avoid erroneous results that may occur from damaged edges.

### Weight Average Molecular Weight by Size Exclusion Chromatography (SEC)

The weight average molecule weight was determined using a Malvern OMNISEC Reveal multi-detector SEC (Malvern PANanalytical, Westborough, MA) with Shodex (Showa Denko America, Inc., New York, NY) columns KF-806L, KF807L and KF-803, chloroform (Sigma-Aldrich, St. Louis, MO; GPC grade) solvent at 0.8 mL/min flow rate, and injection volume of 100 μL at a concentration of 2-3 mg/mL at 30° C.

### EXAMPLES

### Example 1: Preparation of Poly(3-hydroxybutyrate) (P3HB) Solutions

10 grams of P3HB polymer (Biomer, Bayem, Germany) was dried under vacuum at room temperature (about 22° C.) for 24 hours. The average molecular weight of the polymer was determined to be 1400 kDa. The P3HB polymer was then dissolved in 100 mL of chloroform (Sigma Aldrich, St. Louis, MO) in a jacketed glass reactor with a polytetrafluoroethylene (PTFE) stir blade at 75° C. under refluxing conditions for 1 hour. The resulting solution was aged for 24 hours at room temperature (about 22° C.).

### Example 2: Preparation of Poly(3-hydroxybutyrate-co-3-hydroxyvalerate) (PHBV) Solutions

10 grams of PHBV polymer (TianAn Biologic Materials Co., Ltd., Zhejiang, China) with 3% molar modification (i.e., 3 mol % 3-hydroxyvalarate) was dried under vacuum at room temperature (about 22° C.) for 24 hours. The average molecular weight of the polymer was 400 kDa according to the supplier. The PHBV polymer was then mixed with 100 mL of chloroform (Sigma Aldrich) and dissolved in a jacketed glass reactor with a PTFE stir blade at 65° C. under refluxing conditions for 1 hour. The resulting solution was aged for 24 hours at room temperature (about 22° C.).

### Example 3: Preparation of Poly(3-hydroxybutyrate-co-3-hydroxyhexanoate) (P3HB/PHBH) Solutions

1 gram of Poly(3-hydroxybutyrate-co-3-hydroxyhexanoate) polymer (Sigma Aldrich) with a 15.2% molar modification (15.2 mol % 3-hydroxyhexanoate) and 580 kDa average molecular weight according to the supplier and 9 g of poly(3-hydroxybutyrate) (Biomer, Bayern, Germany) was dissolved together in 100 mL of chloroform in a jacketed glass reactor with a PTFE stir blade at 75° C. under refluxing conditions for 1 hour. The resulting solution was aged for 24 hours at room temperature (about 22° C.).

### Example 4: Preparation of Poly(3-hydroxybutyrate-co-3-hydroxyvalerate) (PHBV/Polyethylene Glycol (PEG) Solutions

2.4 gram of Polyethylene glycol polymer (Sigma Aldrich) with 8 kDa average molecular weight according to the supplier was added to the 10% w/v PHBV solution made in Example 2 and dissolved at room temperature (about 22° C.) for 24 hours while magnetically stirring. The ratio of PHBV weight to PEG weight was 5:1 in the final solution.

### Example 5: Preparation of Poly(3-Hydroxybutyrate) Cast Tape on a Polytetrafluoroethylene (PTFE) Substrate Using Methanol for Non-Solvent Induced Phase Separation (NIPS)

A porous PTFE tape (with a thickness of 258 μm and a porosity of 28%) was made according to the methodology of U.S. Pat. No. 3,953,566 to Gore. The porous PTFE tape was attached to a glass plate and then coated with P3HB solution (15 mL) prepared in Example 1 using a 254 μm draw-down bar. The P3HB-coated PTFE tape was then immediately transferred into a bath filled with methanol (VWR International, LLC, Radnor, PA) at room temperature (about 22° C.) for non-solvent induced phase separation. The P3HB coated PTFE tape was kept in the methanol bath for at least 5 minutes until the solvent exchange was completed. The solvent exchanged P3HB/PTFE tape was removed from the bath and air dried at room temperature (about 22° C.) to remove any excess solvent for 24 hours.

### Example 6: Preparation of Poly(3-Hydroxybutyrate) Cast Tape on a Polyethylene (PE) Substrate Using Methanol for Non-solvent Induced Phase Separation

The P3HB solution (10 mL) prepared in Example 1 was coated on a porous ultra-high molecular weight polyethylene (PE) tape having a thickness of 185 μm and a porosity of 25% (made according to U.S. Pat. No. 10,577,468 to Sbriglia) using a 254-μm draw-down bar. The P3HB coated PE tape was immediately submerged into a bath filled with methanol (VWR International, LLC) at room temperature (about 22° C.) for non-solvent induced phase separation. The P3HB coated PE tape was kept in the methanol bath for 5 minutes until the solvent exchange was completed. The solvent exchanged P3HB/PE tape was removed from the bath and air dried at room temperature (about 22° C.) to remove any excess solvent for 24 hours.

### Example 7: Preparation of Poly(3-Hydroxybutyrate) Cast Tape on a Polyethylene (PE) Substrate Using Methanol for Non-Solvent Induced Phase Separation

The P3HB solution prepared in Example 1 was coated on a porous ultra-high molecular weight polyethylene (UHMWPE) tape (made according to U.S. Pat. No. 10,577,468 to Sbriglia) having a thickness of 360 μm and a porosity of 26% using a 254-μm draw-down bar. The P3HB coated PE tape was immediately submerged into a bath filled with methanol (VWR International, LLC) at room temperature (about 22° C.) for non-solvent induced phase separation. The P3HB coated PE tape was kept in the methanol bath for 5 minutes until the solvent exchange was completed. The solvent exchanged P3HB/PE tape was removed from the bath and air dried at room temperature (about 22° C.) to remove any excess solvent for 24 hours.

### Example 8: Preparation of Poly(3-hydroxybutyrate-co-3-hydroxyvalerate) (PHBV) Cast Tape on a Polyethylene (PE) Substrate Using Isopropanol for Non-Solvent Induced Phase Separation

The PHBV solution (15 mL) prepared in Example 2 was coated onto a porous ultra-high molecular weight polyethylene (UHMWPE) tape (made according to U.S. Pat. No. 10,577,468 to Sbriglia) having a thickness of 185 μm and a porosity of 25%, using a 254-μm thick draw-down bar. The PHBV coated PE tape was immediately submerged into a bath filled with isopropyl alcohol (VWR International, LLC) at room temperature (about 22° C.). The solvent exchanged PHBV/PE tape was kept in the isopropyl alcohol bath for 5 min to ensure solvent exchange. The solvent exchanged PHBV/PE tape was removed from the bath and air dried at room temperature (about 22° C.) to remove any excess solvent for 24 hours.

### Example 9: Preparation of Poly(3-hydroxybutyrate-go-3-hydroxyvalerate) (PHBV)/Polyethlene Glycol (PEG) Cast Tape on a Polyethylene Substrate

The PHBV/PEG solution prepared in Example 4 was coated onto a porous ultra-high molecular weight polyethylene (UHMWPE) tape (made according to U.S. Pat. No. 10,577,468 to Sbriglia) having a thickness of 185 μm and a porosity of 25% using a 254-μm draw-down bar. The PHBV/PEG coated PE tape was air dried at room temperature (about 22° C.) for 24 hours to remove the chloroform solvent. The dried PHBV/PEG coated PE tape was submerged in a reverse osmosis water bath at room temperature (about 22° C.) for 24 hours to remove the PEG. The PHBV coated PE tape was then dried under vacuum at room temperature (about 22° C.) for 24 hours.

### Example 10: Preparation of Poly(3-hydroxybutyrate-co-3-hydroxyhexanoate) (P3HB/PHBH) Cast Tape on a Polyethylene Substrate Using Methanol for Non-Solvent Induced Phase Separation

The P3HB/PHBH solution blend prepared in Example 3 was coated onto a porous ultra-high molecular weight polyethylene (UHMWPE) tape (made according to U.S. Pat. No. 10,577,468 to Sbriglia) having a thickness of 185 μm and a porosity of 25% using a 254-μm thick draw-down bar. The P3HB/PHBH coated PE tape was immediately submerged into a bath filled with methanol (VWR International, LLC) at room temperature (about 22° C.) for 10 minutes to ensure solvent exchange. The solvent exchanged P3HB/PHBH-coated PE tape was removed from the methanol bath and air dried at room temperature (about 22° C.) for 24 hours to remove any excess solvent.

### Example 11: Preparation of a Uniaxially Expanded Poly(3-Hydroxybutyrate) Membrane

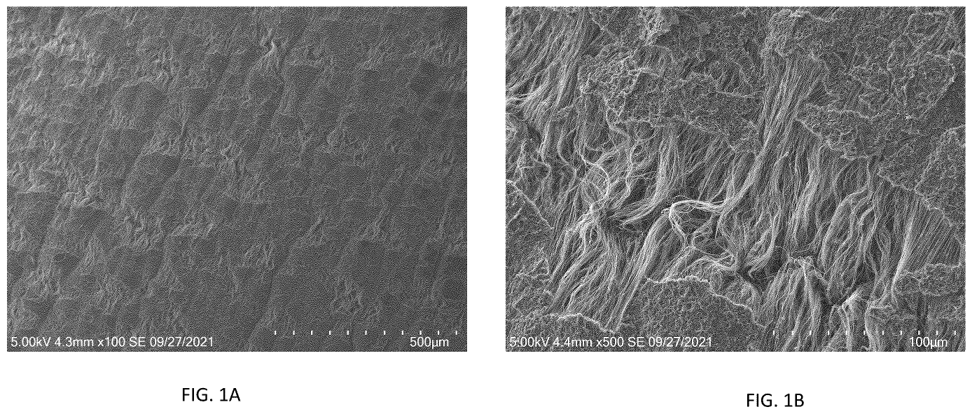

The P3HB/PTFE tape prepared according to Example 5 was used as the starting material for the preparation of a uniaxially expanded P3HB membrane. A rectangular sample (120 mm long and 10 mm wide) was cut from the P3HB/PTFE tape using a razor blade and the sample was restrained between two pneumatic grips with a gauge length of 80 mm (INSTRON® Model 5965 tensile tester equipped with a built-in convection oven, Illinois Tool Works Inc, Norwood, MA). The sample was equilibrated at 110° C. for 1 minute and then uniaxially expanded to 4 times of its original length at a rate of 100%/s. The uniaxially expanded P3HB membrane showed a porous, node and fibril microstructure (see FIGS. 1A and 1B). Properties of the uniaxially expanded P3HB membrane are provided in Table 2.

### Example 12: Preparation of a Uniaxially Expanded Poly(3-Hydroxybutyrate) Membrane

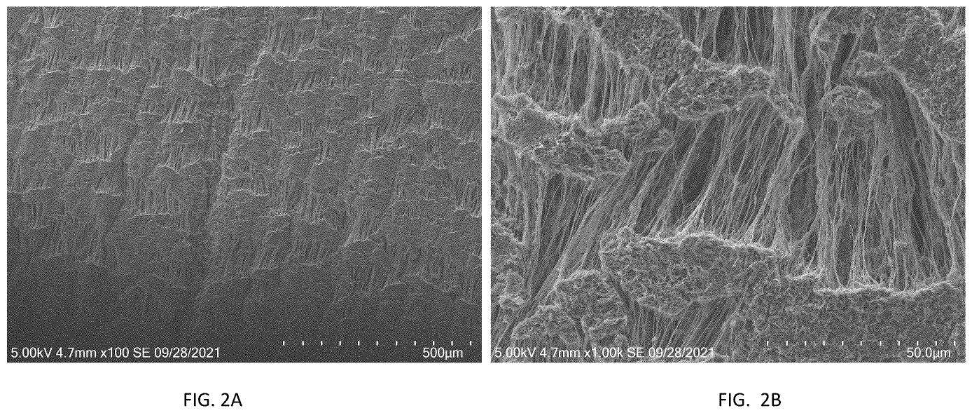

The P3HB/PE tape prepared according to Example 6 was used as the starting material. A rectangular sample (70 mm wide and 150 mm long) was cut from the P3HB/PE tape. The rectangular sample was loaded into a Karo IV biaxial expansion machine (Brückner Maschinenbau GmbH & Co., Siegsdorf, Germany) and thermally equilibrated at 120° C. for 2 minutes. The rectangular sample was then uniaxially expanded to 9 times its original length at a strain rate of 100%/s. An SEM micrograph of the uniaxially expanded sample illustrates the formation of a porous P3HB membrane having a node and fibril microstructure (see FIGS. 2A and 2B). Properties of the uniaxially expanded P3HB membrane are provided in Table 2.

### Example 13: Preparation of a Biaxially Expanded Poly(3-Hydroxybutyrate) Membrane

A poly(3-hydroxybutyrate) coated polyethylene tape (P3HB/PE) was prepared according to Example 6. A rectangular sample (70 mm wide (transverse direction; TD) and 150 mm long (machine direction; MD)) was cut from the P3HB/PE tape. The rectangular sample was loaded into a Karo IV biaxial expansion machine (Brückner Maschinenbau GmbH & Co.) and thermally equilibrated at 120° C. for 2 minutes. The rectangular sample was biaxially expanded (simultaneously in the MD and TD) until it reached a total area ratio of 8 at a strain of 100%/s for both directions (MD & TD) after equilibrated at 120° C. for 2 minutes. The biaxially expanded P3HB membrane was removed from the PE substrate. The specific surface area of the P3HB membrane was measured as 72.03 m²/g. Additional properties of the biaxially expanded P3HB membrane are provided in Table 2.

### Example 14: Preparation of a Biaxially Expanded Poly(3-Hydroxybutyrate) Membrane

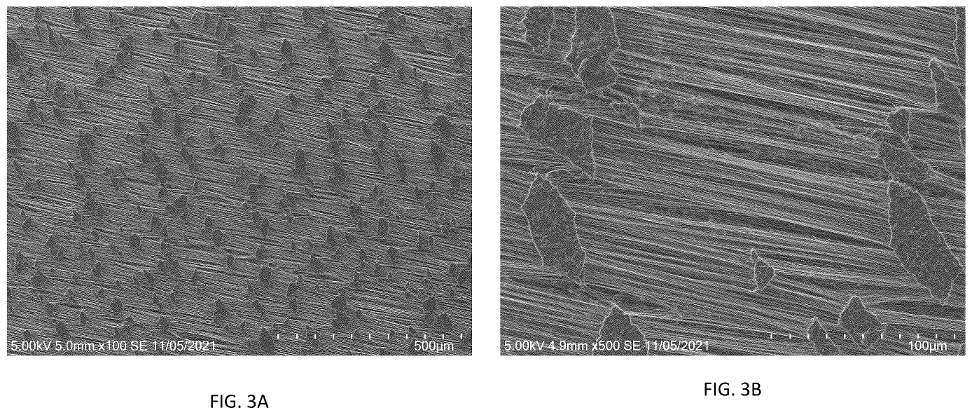

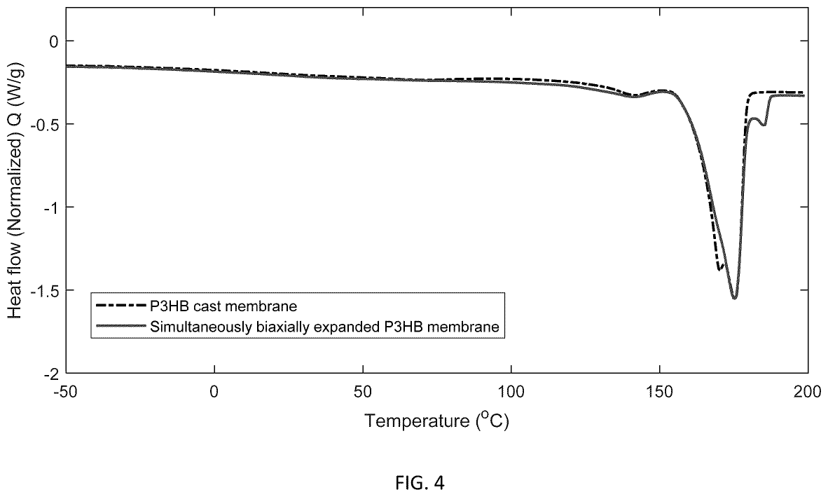

A poly(3-hydroxybutyrate) coated polyethylene tape (P3HB/PE) was prepared according to Example 6. A rectangular sample 70 mm wide (transverse direction; TD) and 150 mm long (machine direction; MD) was cut from the P3HB/PE tape. The rectangular sample was loaded into a Karo IV biaxial expansion machine (Brückner Maschinenbau GmbH & Co.) and thermally equilibrated at 120° C. for 2 minutes. The rectangular sample was biaxially expanded (simultaneously) until it reached an area ratio of 12 at a strain rate of 100%/s for both MD and TD. The biaxially expanded P3HB membrane was removed from the PE substrate. An SEM micrograph of the biaxially expanded membrane showed a porous, node and fibril microstructure (FIGS. 3A and 3B). Differential scanning calorimetry analysis (DSC) was conducted on the P3HB cast film (prior to biaxial expansion) and the biaxially expanded P3HB membrane (FIG. 4). As shown in FIG. 4, the biaxially expanded P3HB membrane has a higher melting peak due to presence of extended chain crystals within the fibrils. Tensile testing was conducted and the matrix tensile strength (MTS) of the porous biaxially expanded P3HB membrane was 28.2 MPa in both the MD and TD directions. The biaxially expanded P3HB membrane was 50 μm thick and had a calculated porosity of 93.6%. Additional properties of the biaxially expanded P3HB membrane are provided in Table 2.

### Example 15: Preparation of a Biaxially Expanded Poly(3-Hydroxybutyrate) Membrane

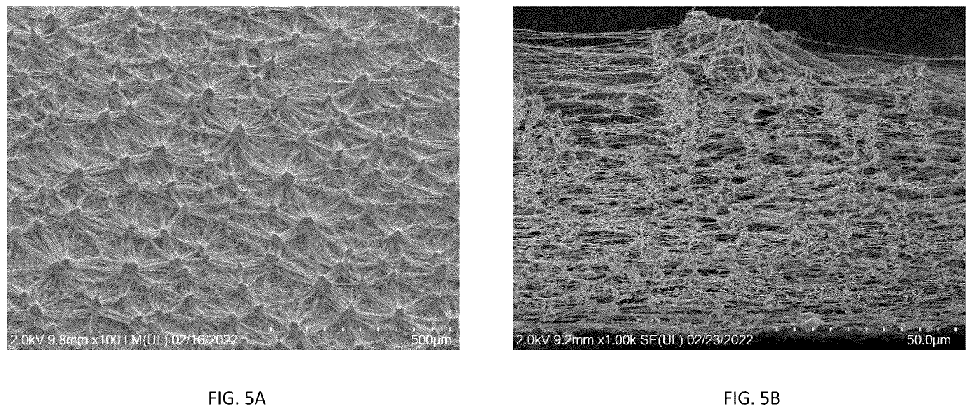

A poly(3-hydroxybutyrate) coated polyethylene tape (P3HB/PE) was prepared according to Example 7. A rectangular sample 70 mm wide (transverse direction; TD) and 150 mm long (machine direction; MD) was cut from the P3HB/PE tape. The rectangular sample was loaded into a Karo IV biaxial expansion machine (Brückner Maschinenbau GmbH & Co.) and thermally equilibrated at 120° C. for 2 minutes. The rectangular sample was biaxially expanded (simultaneously) until it reached an area ratio of 30 at a strain of 100%/s in both the MD and the TD. The biaxially expanded P3HB membrane was removed from the PE substrate. The calculated porosity of the biaxially expanded P3HB membrane was 96%. The ATEQ airflow through the membrane was measured as 161 LIhr. An SEM micrograph of the simultaneously biaxially expanded P3HB membrane illustrates the porous microstructure comprising nodes and fibrils (FIGS. 5A and 5B). Properties of the biaxially expanded P3HB membrane are provided in Table 2.

### Example 16: Preparation of a Biaxially Expanded Poly(3-Hydroxybutyrate) Membrane

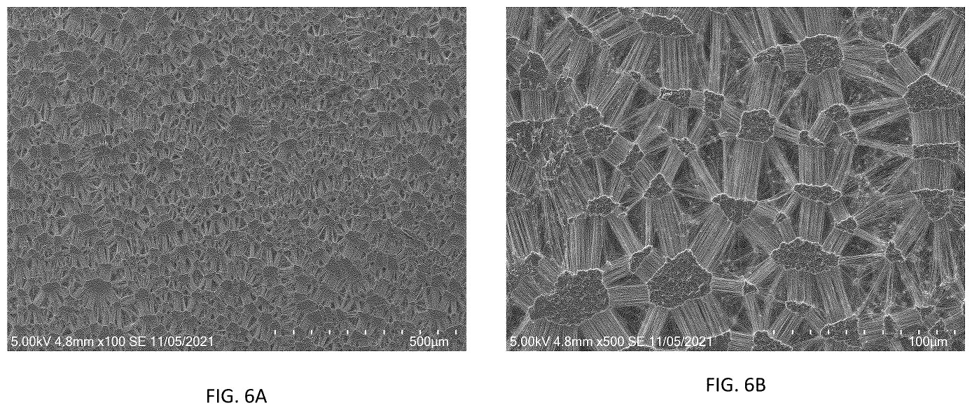

A poly(3-hydroxybutyrate) coated polyethylene tape (P3HB/PE) was prepared according to Example 6. A rectangular sample 70 mm wide (transverse direction; TD) and 150 mm long (machine direction; MD) was cut from the P3HB/PE tape. The rectangular sample was loaded into a Karo IV biaxial expansion machine (Brückner Maschinenbau GmbH & Co.) and thermally equilibrated at 140° C. for 2 minutes. The rectangular sample was biaxially expanded (simultaneously) until it reached an area ratio of 4 at a strain of 100%/s in both the MD and the TD. The biaxially expanded P3HB membrane was removed from the PE substrate. An SEM micrograph of the biaxially expanded P3HB membrane illustrates a porous microstructure comprises nodes and fibrils (FIGS. 6A and 6B). Properties of the biaxially expanded P3HB membrane are provided in Table 2.

### Example 17: Preparation of a Biaxially Expanded Poly(3-hydroxybutyrate-co-3-hydroxyvalerate) Membrane

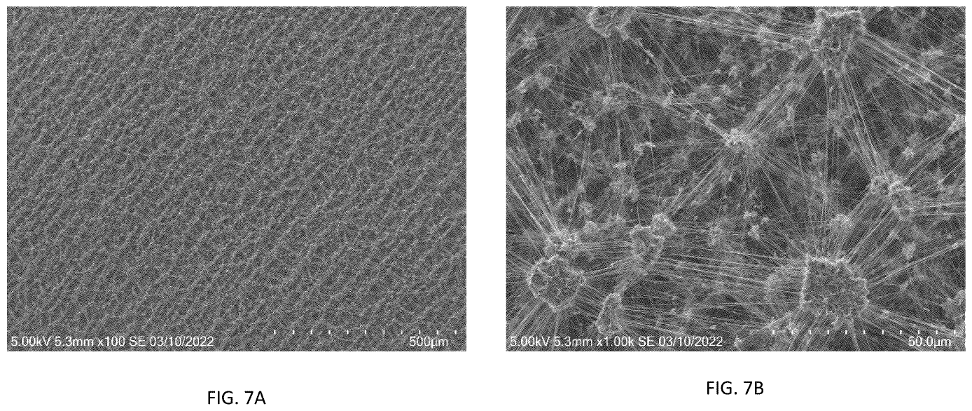

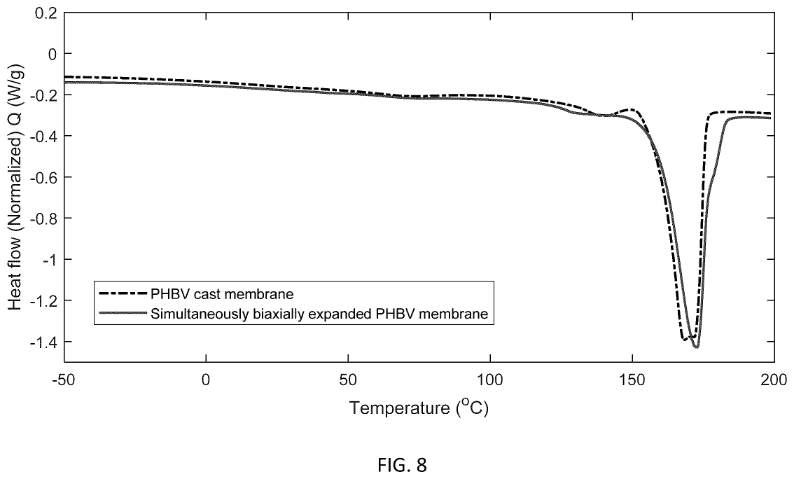

A poly(3-hydroxybutyrate-co-3-hydroxyvalerate) (PHBV) coated polyethylene tape (PHBV/PE) was prepared according to Example 8. A rectangular sample 70 mm wide (transverse direction; TD) and 150 mm long (machine direction; MD) was cut from the PHBV/PE tape. The rectangular sample was loaded into a Karo IV biaxial expansion machine (Brückner Maschinenbau GmbH & Co.) and thermally equilibrated at 120° C. for 2 minutes. The rectangular sample was biaxially expanded (simultaneously in the MD and TD) until it reached an area ratio of 16 at a strain rate of 100%/s for the MD and 10%/s the TD. The biaxially expanded PHBV membrane was removed from the PE substrate. An SEM micrograph of the biaxially expanded PHBV membrane illustrates a porous microstructure comprising nodes and fibrils (FIGS. 7A and 7B). Differential scanning calorimetry analysis (DSC) was conducted on the PHBV cast film (prior to biaxial expansion) and the biaxially expanded PHBV membrane (FIG. 8). As shown in FIG. 8, the biaxial expanded PHBV membrane has a higher melting peak due to the presence of extended chain crystals within the fibrils. The calculated porosity of the biaxially expanded PHBV membrane was 94%. ATEQ airflow through the membrane was measured as 321 L/hr. Additional properties of the biaxially expanded PHBV membrane are provided in Table 2.

### Example 18: Preparation of Sequentially Expanded PHBV Membrane

A poly(3-hydroxybutyrate-co-3-hydroxyvalerate) (PHBV) coated polyethylene tape (PHBV/PE) was prepared according to Example 8. A rectangular sample 70 mm wide (transverse direction; TD) and 150 mm long (machine direction; MD) was cut from the PHBV/PE tape. The rectangular sample was loaded into a Karo IV biaxial expansion machine (Brückner Maschinenbau GmbH & Co.) and thermally equilibrated at 120° C. for 2 minutes. The rectangular sample was first expanded in MD four times its original length at a strain rate of 10%/s and then was subsequently expanded in TD at 100%/s until it reached a total area ratio of 16. The biaxially expanded PHBV membrane was removed from the PE substrate. The thickness of the standalone biaxially expanded PHBV membrane was 26 μm with a calculated porosity of 93.8%. ATEQ airflow through the biaxially expanded PHBV membrane was 313 L/hr and water entry pressure (WEP) was 6.89 kPa. Additional properties of the biaxially expanded PHBV membrane are provided in Table 2.

### Example 19: Preparation of Biaxially Expanded Poly(3-hydroxybutyrate-co-3-hydroxyvalerate) Membrane Using Polyethylene Glycol as a Porogen

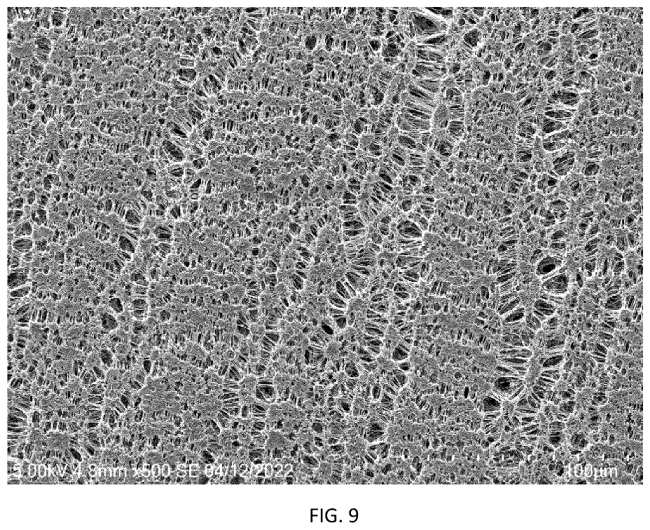

A poly(3-hydroxybutyrate-co-3-hydroxyvalarate) tape was prepared according to Example 9 (polyethylene glycol porogen previously removed). A rectangular sample 70 mm wide (transverse direction; TD) and 150 mm long (machine direction; MD) was cut from the PHBV tape. The rectangular sample was loaded into a Karo IV biaxial expansion machine (Brückner Maschinenbau GmbH & Co.) and thermally equilibrated at 120° C. for 2 minutes. The rectangular sample was biaxially expanded (simultaneously) until it reached an area ratio of 4 at a strain rate of 100%/s for both the MD and the TD. The biaxially expanded PHBV membrane was removed from the PE substrate. An SEM micrograph of the biaxially expanded PHBV membrane showed a porous structure comprising nodes and fibrils (FIG. 9). The biaxially expanded PHBV membrane was 20 μm thick and had a calculated porosity of 68%. Additional properties of the biaxially expanded PHBV membrane are provided in Table 2.

### Example 20: Preparation of Uniaxially Expanded P3HB/PHBH Membrane

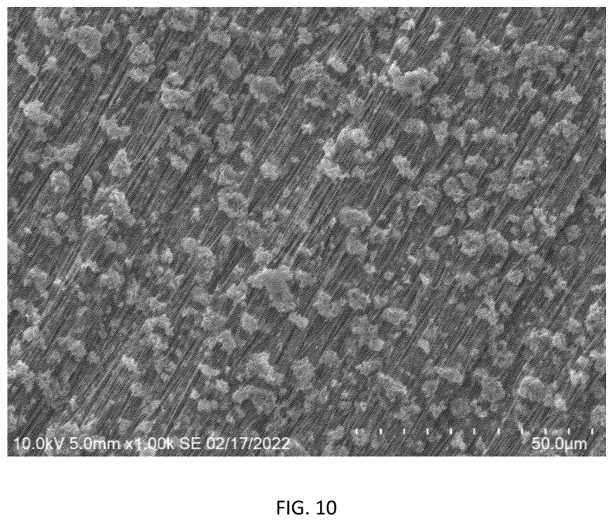

A poly(3-hydroxybutyrate-co-3-hydroxyhexanoate) (P3HB/PHBH) coated polyethylene tape was prepared according to Example 10. A rectangular sample 120 mm long and 10 mm wide was cut from the P3HB/PHBH tape using a razor blade. The rectangular sample was restrained between two pneumatic grips with a gauge length of 80 mm (INSTRON® Model 5965 tensile tester equipped with a built-in convection oven, Illinois Tool Works Inc, Norwood, MA). The sample was equilibrated at 120° C. for 1 minute and then uniaxially expanded to 5 times of its original length at a rate of 100%/s. The uniaxially expanded P3HB/PHBH membrane showed a porous microstructure comprising nodes and fibrils (FIG. 10). Additional properties of the uniaxially expanded P3HB/PHBH membrane are provided in Table 2.

### Example 21: Preparation of a Densified Poly(3-Hydroxybutyrate) Film from an Expanded P3HB Membrane

A biaxially expanded P3HB membrane made according to Example 14 was layered between two polyimide films (KAPTON®, E. I. du Pont de Nemours and Company, Wilmington, DE) and densified between two silicone rolls set at 120° C. The compression force was set to 400 N/mm with a line speed of 1 meter per minute. The resulting densified article had a thickness of 12 μm and a mass per area (MPA) of 3.67 g/m². Properties of the densified P3HB film are provided in Table 2.

### Example 22: Preparation of Biaxially Expanded Poly(3-Hydroxybutyrate)/Polyethylene Composite (P3HB/PE)

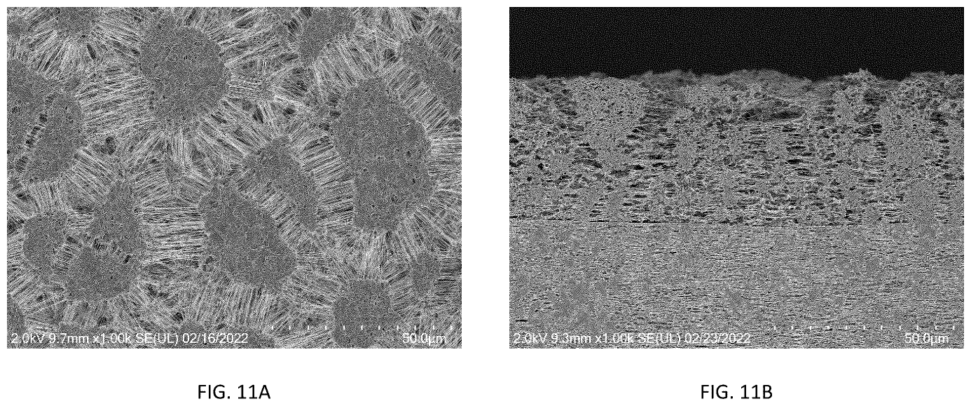

A poly(3-hydroxybutyrate)/polyethylene (P3HB/PE) composite tape was prepared according to Example 7. A rectangular sample 70 mm wide (MD) and 150 mm long (TD) was cut from the P3HB/PE composite tape. The rectangular sample was loaded into a Karo IV biaxial expansion machine (Brückner Maschinenbau GmbH & Co.) and thermally equilibrated at 120° C. for 2 minutes. The rectangular sample was biaxially expanded (simultaneously) until it reached an area ratio of 4 at a strain of 100%/s for both the MD and the TD. An SEM micrograph of the biaxially expanded P3HB/PE composite showed a porous microstructure having nodes and fibrils (FIGS. 11A and 11B). FIG. 11A is a top view of the P3HB/PE composite illustrating the node and fibril microstructure of the P3HB layer. FIG. 11B is a cross-sectional view illustrating the microstructure of the layered porous P3HB/PE composite.

### Comparative Example 23: Preparation of a Uniaxially Stretched Dense Poly(3-hydroxybutyrate) Film without the Aid of a Stretchable Substrate

The solution prepared as described in Example 1 was coated on a glass plate using a 254-μm draw-down bar. The P3HB coated glass was then covered with a glass cover and the chloroform solvent was slowly evaporated at room temperature (about 22° C.) for 24 hours, resulting in a dense P3HB film. A rectangular sample 120 mm long and 10 mm wide was cut from the dense P3HB film a razor blade and the sample was restrained between two pneumatic grips with a gauge length of 80 mm (INSTRON® Model 5965 tensile tester equipped with a built-in convection oven, Illinois Tool Works Inc, Norwood, MA). The restrained dense P3HB film was equilibrated at 100° C. for 1 minute and then uniaxially stretched until 25% strain was achieved at a rate of 100%/s. The dense P3HB film was unable to stretch beyond 25% due to the formation of macroscopic defects beyond this strain, illustrating the inability to form a porous P3HB membrane having a microstructure of nodes and fibrils.

### Comparative Example 24: Uniaxial Expansion of Dense Poly(3-hydroxybutyrate-co-3-hydroxyvalerate) Film

A dense poly(3-hydroxybutyrate-co-3-hydroxyvalarate) film (10 μm thick) was obtained from Goodfellow Corporation (Pittsburgh, PA). The dense PHBV film was cut into a rectangular shape (120 mm long and 10 mm wide). The rectangular PHBV dense film sample was restrained between two pneumatic grips with a gauge length of 80 mm (INSTRON® 5965 tensile tester equipped with a built-in convection oven, Illinois Tool Works Inc, Norwood, MA). The PHBV dense film sample was equilibrated at 120° C. for 1 min and then uniaxially expanded to 2 times its original length at a rate of 100%/s. However, the PHBV sample was brittle and failed to form a porous PHBV membrane having a microstructure of nodes and fibrils.

### Comparative Example 25: Uniaxially Expanded Layered Composite of Porous PTFE Tape with Dense PHVB Film

A porous PTFE tape (with a thickness of 258 μm and a porosity of 28%) was made according to the methodology of U.S. Pat. No. 3,953,566 to Gore and cut using a razor blade. A dense 10 μm thick poly(3-hydroxybutyrate-co-3-hydroxyvalarate) film (obtained from Goodfellow Corporation, Pittsburgh, PA) was also cut into the same dimensions and layered on top of the porous PTFE tape. The layered materials were sandwiched between two skived PTFE films (non-porous; used a release liner) and metal plates. The sandwiched materials were placed in a hydraulic press (Carver, Inc., Wabash, IN) and thermally equilibrated at 175° C. for 2 minutes. The thermally equilibrated stacked materials were compressed at 500 lbs (about 3.45 MPa) for 30 seconds. The skived PTFE films and metal plates were removed to obtain the layered PHVB/PTFE composite material. A rectangular sample 120 mm long and 10 mm wide was cut from the layered PHVB/PTFE composite using a razor blade and then restrained between two pneumatic grips with a gauge length of 80 mm (INSTRON® 5965 tensile tester equipped with a built-in convection oven, Illinois Tool Works Inc, Norwood, MA). The layered PHVB/PTFE composite sample was equilibrated at 120° C. for 1 minute and then uniaxially expanded to 2 times of its original length at a rate of 100%/s. However, the PHBV layer fractured and did not result in a porous PHBV membrane having a microstructure of nodes and fibrils.

TABLE 2
Sample Properties

| | | | | | | | Water |
|---|---|---|---|---|---|---|---|
| | Mass | | Po- | | | | Entry |
| Exam- | Per | Thick- | ros- | | ATEQ | Surface | Pressure |
| ple | Area | ness | ity | MTS | Airflow | Area | (WEP) |
| # | (g/m²) | (μm) | (%) | (MPa) | (L/hr) | (m²/g) | (kPa) |
| 13 | 2.95 | 35 | 93 | | 128.6 | 72.03 | |
| 14 | 4.14 | 50 | 93.6 | 28.2 | | | |
| 15 | 1.6 | 36 | 96 | | 161 | | |
| 17 | 1.88 | 26 | 94 | | 321 | | |
| 18 | 1.91 | 26 | 93.8 | | 313 | 29.026 | 6.89 |
| 19 | 7.68 | 20 | 68 | | 3.1 | | |
| 21 | 3.67 | 12 | | | | | |

### Example 26: Preparation of Poly(3-hydroxy-2,2-dimethylcuprate) (P3H(Me)₂B) Solutions

Poly(3-hydroxy-2,2-dimethylbuyrate) (P3H(Me)₂B) was synthesized according to the methodology described in Zhou et al. “Chemically circular, mechanically tough, and melt-processable polyhydroxyalkanoates”, Science (2023) 380, 64-69. 0.68 grams of P3H(Me)₂B polymer was dried under vacuum at room temperature (about 22° C.) for 24 hours. The P3H(Me)₂B polymer was then dissolved in 5 mL of chloroform (Sigma Aldrich, St. Louis, MO) in a glass vial with a polytetrafluoroethylene (PTFE) stir bar at 70° C. for 6 hours. The resulting solution was aged for 24 hours at room temperature (about 22° C.).

### Example 27: Preparation of poly(3-hydroxy-2,2-diethylbuyrate) (P3H(Et)₂B) Solutions

P3H(Et)₂B is synthesized according to the methodology described in Zhou et al., supra. 10 grams of P3H(Et)₂B polymer is dried under vacuum at room temperature (about 22° C.) for 24 hours. The P3H(Et)₂B polymer is then dissolved in 100 mL of chloroform (Sigma Aldrich, St. Louis, MO) in a jacketed glass reactor with a polytetrafluoroethylene (PTFE) stir blade at 75° C. under refluxing conditions for 1 hour. The resulting solution is aged for 24 hours at room temperature (about 22° C.).

### Example 28: Preparation of poly(3-hydroxybutyrate-co-4hydroxybutyrate) (P3HB4HB) Solutions

Poly(3-hydroxybutyrate-co-4-hydroxybutyrate) (P3HB4HB) is synthesized according to the methodology described in Hor et al., “Chemical synthesis of high molecular weight poly(3-hydroxybutyrate-co-3-hydroxybutyrate)”, Polymer (1995) 36 (24) 4703-4705. 10 grams of P3HB4HB polymer is dried under vacuum at room temperature (about 22° C.) for 24 hours. The P3HB4HB polymer is then dissolved in 100 mL of chloroform (Sigma Aldrich, St. Louis, MO) in a jacketed glass reactor with a polytetrafluoroethylene (PTFE) stir blade at 75° C. under refluxing conditions for 1 hour. The resulting solution is aged for 24 hours at room temperature (about 22° C.).

### Example 29: Preparation of poly(3-hydroxy-2,2-dimethylbuyrate) (P3H(Me)₂B) Cast Tape on a Polytetrafluoroethylene (PTFE) Substrate Using Methanol for Non-Solvent Induced Phase Separation (NIPS)

A porous PTFE tape (with a thickness of 258 μm and a porosity of 28%) was made according to the methodology of U.S. Pat. No. 3,953,566 to Gore. The porous PTFE tape was attached to a glass plate and then coated with P3H(Me)₂B solution (15 mL) described in Example 25 using a 254 μm draw-down bar. The P3H(Me)₂B-coated PTFE tape was then immediately transferred into a bath filled with methanol (VWR International, LLC, Radnor, PA) at room temperature (about 22° C.) for non-solvent induced phase separation. The P3H(Me)₂B coated PTFE tape was kept in the methanol bath for at least 5 minutes until the solvent exchange was completed. The solvent exchanged P3H(Me)₂B/PTFE tape was removed from the methanol bath and air dried at room temperature (about 22° C.) to remove any excess solvent for 24 hours.

### Example 30: Preparation of poly(3-hydroxy-2,2-dimethylbuyrate) (P3H(Me)₂B) Cast Tape on a Polyethylene (PE) Substrate Using Methanol for Non-Solvent Induced Phase Separation (NIPS)

The P3H(Me)₂B solution (5 mL) prepared as described Example 26 was coated on a porous ultra-high molecular weight polyethylene (PE) tape having a thickness of 185 μm and a porosity of 25% (made according to the methodology described in U.S. Pat. No. 10,577,468 to Sbriglia) using a 304.8-μm draw-down bar. The P3H(Me)₂B coated PE tape was immediately submerged into a bath filled with methanol (VWR International, LLC) at room temperature (about 22° C.) for non-solvent induced phase separation. The P3H(Me)₂B coated PE tape was kept in the methanol bath for 5 minutes until the solvent exchange was completed. The solvent exchanged P3H(Me)₂B/PE tape was removed from the bath, air dried at room temperature (about 22° C.) to remove any excess solvent for 24 hours.

### Example 31: Preparation of poly(3-hydroxy-2,2-diethylbuyrate) (P3H(Et)₂B) Cast Tape on a Polytetrafluoroethylene (PTFE) Substrate Using Methanol for Non-Solvent Induced Phase Separation (NIPS)

A porous PTFE tape (with a thickness of 258 μm and a porosity of 28%) is made according to the methodology of U.S. Pat. No. 3,953,566 to Gore. The porous PTFE tape is attached to a glass plate and then coated with P3H(Et)₂B solution (15 mL) prepared as described in Example 27 using a 254 μm draw-down bar. The P3H(Et)₂B-coated PTFE tape is then immediately transferred into a bath filled with methanol (VWR International, LLC, Radnor, PA) at room temperature (about 22° C.) for non-solvent induced phase separation. The P3H(Et)₂B coated PTFE tape is kept in the methanol bath for at least 5 minutes until the solvent exchange is completed. The solvent exchanged P3H(Et)₂B/PTFE tape is removed from bath and air dried at room temperature (about 22° C.) to remove any excess solvent for 24 hours.

### Example 32: Preparation of poly(3-hydroxy-2,2-diethylbuyrate) (P3H(Et)₂B) Cast Tape on a Polyethylene (PE) Substrate Using Methanol for Non-Solvent Induced Phase Separation (NIPS)

The P3H(Et)₂B solution (10 mL) prepared as described in Example 27 is coated on a porous ultra-high molecular weight polyethylene (PE) tape having a thickness of 185 μm and a porosity of 25% (made according to the methodology disclosed in U.S. Pat. No. 10,577,468 to Sbriglia) using a 254-μm draw-down bar. The P3H(Et)₂B coated PE tape is immediately submerged into a bath filled with methanol (VWR International, LLC) at room temperature (about 22° C.) for non-solvent induced phase separation. The P3H(Et)₂B coated PE tape is kept in the methanol bath for 5 minutes until the solvent exchange is completed. The solvent exchanged P3H(Et)₂B/PE tape is removed from the bath, air dried at room temperature (about 22° C.) to remove any excess solvent for 24 hours.

### Example 33: Preparation of poly(3-hydroxybutyrate-co-4-hydroxybutyrate) (P3HB4HB) Cast Tape on a Polytetrafluoroethylene (PTFE) Substrate Using Methanol for Non-Solvent Induced Phase Separation (NIPS)

A porous PTFE tape (with a thickness of 258 μm and a porosity of 28%) is made according to the methodology of U.S. Pat. No. 3,953,566 to Gore. The porous PTFE tape is attached to a glass plate and then is coated with P3HB4HB solution (15 mL) prepared as described in Example 28 using a 254 μm draw-down bar. The P3HB4HB-coated PTFE tape is then immediately transferred into a bath filled with methanol (VWR International, LLC, Radnor, PA) at room temperature (about 22° C.) for non-solvent induced phase separation. The P3HB4HB coated PTFE tape is kept in the methanol bath for at least 5 minutes until the solvent exchange is completed. The solvent exchanged P3HB4HB/PTFE tape is removed from bath and air dried at room temperature (about 22° C.) to remove any excess solvent for 24 hours.

### Example 34: Preparation of poly(3-hydroxybutyrate-co-4-hydroxybutyrate) (P3HB4HB) Cast Tape on a Polyethylene (PE) Substrate Using Methanol for Non-Solvent Induced Phase Separation (NIPS)

The P3HB4HB solution (10 mL) prepared as described in Example 28 is coated on a porous ultra-high molecular weight polyethylene (PE) tape having a thickness of 185 μm and a porosity of 25% (made according to the methodology described in U.S. Pat. No. 10,577,468 to Sbriglia) using a 254-μm draw-down bar. The P3HB4HB coated PE tape is immediately submerged into a bath filled with methanol (VWR International, LLC) at room temperature (about 22° C.) for non-solvent induced phase separation. The P3HB4HB coated PE tape is kept in the methanol bath for 5 minutes until the solvent exchange is completed. The solvent exchanged P3HB4HB/PE tape is removed from the bath and air dried at room temperature (about 22° C.) to remove any excess solvent for 24 hours.

### Example 35: Preparation of a Uniaxially Expanded poly(3-hydroxy-2,2-dimethylbuyrate) (P3H(Me)₂B) Membrane

The P3H(Me)₂B/PE tape prepared according to Example 30 was used as the starting material. A rectangular sample (12.5 mm wide and 75.4 mm long) was cut from the P3H(Me)₂B/PE tape. The rectangular sample was loaded between two pneumatic grips with a gauge length of 30 mm (INSTRON @5965 tensile tester equipped with a built-in convection oven, Illinois Tool Works Inc, Norwood, MA) and thermally equilibrated at 120° C. for 2 minutes. The rectangular sample was then uniaxially expanded to 1.4× times its original length at a strain rate of 10%/s. This process produced a uniaxially expanded porous P3H(Me)₂B membrane having a node and fibril microstructure.

### Example 36: Preparation of a Uniaxially Expanded Poly(3-hydroxy-2,2-diethylbuyrate) Membrane

The P3H(Et)₂B/PE tape prepared according to Example 32 is used as the starting material. A rectangular sample (70 mm wide and 150 mm long) is cut from the P3H(Et)₂B/PE tape. The rectangular sample is loaded into a Karo IV biaxial expansion machine (Brückner Maschinenbau GmbH & Co., Siegsdorf, Germany) and thermally equilibrated at 120° C. for 2 minutes. The rectangular sample is then uniaxially expanded to 4 times its original length at a strain rate of 10%/s. The uniaxially expanded P3H(Et)₂B membrane is removed from the PE substrate. This process should produce a uniaxially expanded porous P3H(Et)₂B membrane having a node and fibril microstructure.

### Example 37: Preparation of a Uniaxially Expanded Poly(3-hydroxybutyrate-co-4-hydroxybutyrate) (P3HB4HB) Membrane

The P3HB4HB/PE tape prepared according to Example 34 is used as the starting material. A rectangular sample (70 mm wide and 150 mm long) is cut from the P3HB4HB/PE tape. The rectangular sample is loaded into a Karo IV biaxial expansion machine (Brückner Maschinenbau GmbH & Co., Siegsdorf, Germany) and thermally equilibrated at 120° C. for 2 minutes. The rectangular sample is then uniaxially expanded to 4 times its original length at a strain rate of 10%/s. The uniaxially expanded P3HB4HB membrane is removed from the PE substrate. This process should produce a uniaxially expanded porous P3HB4HB membrane having a node and fibril microstructure.

### Example 38: Preparation of a Biaxially Expanded poly(3-hydroxy-2,2-dimethylbuyrate) (P3H(Me)₂B) Membrane

A P3H(Me)₂B coated polyethylene tape (P3H(Me)₂B/PTFE) was prepared according to Example 29. A rectangular sample 70 mm wide (transverse direction; TD) and 150 mm long (machine direction; MD) was cut from the P3H(Me)₂B/PTFE tape. The rectangular sample was loaded into a Karo IV biaxial expansion machine (Brückner Maschinenbau GmbH & Co.) and thermally equilibrated at 120° C. for 2 minutes. The rectangular sample was biaxially expanded (simultaneously) until it reached an area ratio of 4 at a strain of 100%/s in both the MD and the TD. This process produced a biaxially expanded P3H(Me)₂B porous membrane comprising nodes and fibrils.

### Example 39: Preparation of a Biaxially Expanded poly(3-hydroxy-2,2-diethylbuyrate) (P3H(Me)₂B) Membrane

A P3H(Et)₂B coated polyethylene tape (P3H(Et)₂B/PTFE) is prepared according to Example 31. A rectangular sample 70 mm wide (transverse direction; TD) and 150 mm long (machine direction; MD) is cut from the P3H(Et)₂B/PTFE tape. The rectangular sample is loaded into a Karo IV biaxial expansion machine (Brückner Maschinenbau GmbH & Co.) and thermally equilibrated at 120° C. for 2 minutes. The rectangular sample is biaxially expanded (simultaneously) until it reaches an area ratio of 4 at a strain of 100%/s in both the MD and the TD. This process should produce a biaxially expanded P3H(Et)₂B porous membrane comprising nodes and fibrils.

### Example 40: Preparation of a Biaxially Expanded poly(3-hydroxybutyrate-co-4-hydroxybutyrate) (P3HB4HB) Membrane

A P3HB4HB coated polyethylene tape (P3HB4HB/PTFE) is prepared according to Example 33. A rectangular sample 70 mm wide (transverse direction; TD) and 150 mm long (machine direction; MD) is cut from the P3HB4HB/PTFE tape. The rectangular sample is loaded into a Karo IV biaxial expansion machine (Brückner Maschinenbau GmbH & Co.) and thermally equilibrated at 120° C. for 2 minutes. The rectangular sample is biaxially expanded (simultaneously) until it reaches an area ratio of 4 at a strain of 100%/s in both the MD and the TD. This process should produce a biaxially expanded P3HB4HB porous membrane comprising nodes and fibrils.

### Example 41: Preparation of Poly(3-Hydroxybutyrate-co-4-Hydroxybutyrate) (P3HB4HB) Solutions

10 grams of P3HB4HB polymer (Helian Polymers, Belfeld, Netherlands) was dried under vacuum at room temperature (about 22° C.) for 24 hours. The P3HB4HB polymer was then dissolved in 100 mL of chloroform (Sigma Aldrich, St. Louis, MO) in a jacketed glass reactor with a polytetrafluoroethylene (PTFE) stir blade at 75° C. under refluxing conditions for 4 hours. The resulting solution was aged for 24 hours at room temperature (about 22° C.).

### Example 42: Preparation of Poly(3-Hydroxybutyrate-co-4-Hydroxybutyrate) (P3HB4HB) Cast Tape on a Polyethylene (PE) Substrate Using Methanol for Non-Solvent Induced Phase Separation

The P3HB4HB solution prepared in Example 41 was coated on a porous ultra-high molecular weight polyethylene (UHMWPE) tape (made according to U.S. Pat. No. 10,577,468 to Sbriglia) having a thickness of 360 μm and a porosity of 26% using a 304.8-μm draw-down bar. The P3HB4HB coated PE tape was immediately submerged into a bath filled with methanol (VWR International, LLC) at room temperature (about 22° C.) for non-solvent induced phase separation. The P3HB4HB coated PE tape was kept in the methanol bath for 10 minutes until the solvent exchange was completed. The solvent exchanged P3HB4HB/PE tape was removed from the bath, air dried at room temperature (about 22° C.) to remove any excess solvent for 24 hours.

### Example 43: Preparation of a Uniaxially Expanded Poly(3-Hydroxybutyrate-co-4-Hydroxybutyrate) Membrane

The P3H4HB/PE tape prepared according to Example 42 was used as the starting material. A rectangular sample (25.4 mm wide and 75.4 mm long) was cut from the P3H4HB/PE tape. The rectangular sample was loaded between two pneumatic grips with a gauge length of 30 mm (INSTRON 05965 tensile tester equipped with a built-in convection oven, Illinois Tool Works Inc, Norwood, MA) and thermally equilibrated at 60° C. for 2 minutes. The rectangular sample was then uniaxially expanded to 1.4× times its original length at a strain rate of 10%/s. This process produced a uniaxially expanded porous P3H4HB membrane having a node and fibril microstructure.

### Example 44: Preparation of a Poly(3-hydroxybutyrate) (P3HB) Monofilament

A poly(3-hydroxybutyrate) coated polyethylene tape (P3HB/PE) was prepared according to Example 6. A rectangular sample 70 mm wide (transverse direction; TD) and 150 mm long (machine direction; MD) was cut from the P3HB/PE tape. The rectangular sample was loaded into a Karo IV biaxial expansion machine (Brückner Maschinenbau GmbH & Co.) and thermally equilibrated at 120° C. for 2 minutes. The rectangular sample was biaxially expanded (simultaneously) until it reached an area ratio of 9 at a strain of 100%/s in both the MD and the TD. The biaxially expanded P3HB membrane was removed from the PE substrate. This membrane was then slit to create a 1.7 mm wide, 35 μm thick monofilament with node and fibril microstructure.

### Example 45: Preparation of a poly(3-hydroxybutyrate-co-3-hydroxyvalerate) (PHBV) Monofilament

A poly(3-hydroxybutyrate-co-3-hydroxyvalerate) (PHBV) coated polyethylene tape (PHBV/PE) was prepared according to Example 8. A rectangular sample 70 mm wide (transverse direction; TD) and 150 mm long (machine direction; MD) was cut from the PHBV/PE tape. The rectangular sample was loaded into a Karo IV biaxial expansion machine (Brückner Maschinenbau GmbH & Co.) and thermally equilibrated at 120° C. for 2 minutes. The rectangular sample was biaxially expanded (simultaneously) until it reached an area ratio of 4 at a strain of 100%/s in both the MD and the TD. The biaxially expanded PHBV membrane was removed from the PE substrate. This membrane was then slit to create a 1.5 mm wide, 36 μm thick monofilament with node and fibril microstructure. The monofilament had a porosity of 84.7%.

The disclosure of this application has been described above both generically and with regard to specific embodiments. It will be apparent to those skilled in the art that various modifications and variations can be made in the embodiments without departing from the scope of the disclosure. Thus, it is intended that the embodiments cover the modifications and variations of this disclosure provided they come within the scope of the appended claims and their equivalents.

1. A method comprising:
depositing a partially crystallized polyhydroxyalkanoate (PHA) polymer on a substrate at a deposition temperature below a melting temperature (Tₘ) of the PHA polymer to form a PHA-substrate composite; and
expanding the PHA-substrate composite at a temperature between the glass transition temperature (T_{g}) of the PHA polymer and the melting temperature (Tₘ) of the PHA polymer to form a porous expanded PHA composite comprising a porous PHA material having a microstructure comprising:
a plurality of nodes; and
a plurality of fibrils interconnecting the plurality of nodes, each said fibril defining a fibril axis.

2. The method of claim 1, wherein the fibrils comprise extended chain crystals of the PHA polymer oriented along the fibril axis, wherein the extended chain crystals of the PHA polymer have a melting temperature that is higher than the Tₘ of the PHA polymer prior to expanding.

3. The method of claim 1, wherein the depositing the partially crystallized PHA polymer comprises:
dissolving the PHA polymer in a solvent to form a PHA solution;
casting the PHA solution on the substrate; and
at least partially crystallizing the PHA polymer by partially removing the solvent, adjusting the deposition temperature, or a combination thereof.

4. The method of claim 1, further comprising separating the porous PHA material from the porous expanded PHA composite to form a self-supporting porous PHA material in the form of a membrane, a tube, a sheet, or a three-dimensional shape;
wherein the self-supporting porous PHA material has a porosity from 25% to 99%; or
wherein the self-supporting porous PHA material has a matrix tensile strength of at least 5 MPa in a machine direction (MD) and/or a transverse direction (TD); or
wherein a total surface area of the self-supporting porous PHA material per unit mass is from 20 m²/q to 80 m²/g.

5.-8. (canceled)

9. The method of claim 1, wherein the PHA-substrate composite is expanded uniaxially, biaxially, or radially at a temperature lower than 10° C. below the Tₘ of the PHA polymer;
or wherein the PHA-substrate composite is expanded at a rate from 1%/s to 1000%/s;
or wherein the PHA-substrate composite has an expansion ratio from 1:1.1 to 1:100.

10.-12. (canceled)

13. The method of claim 1, wherein the PHA polymer comprises monomers, homopolymers or copolymers comprising 3-hydroxybutyrate, 3-hydroxyvalerate, 4-hydroxybutyrate, 3-hydroxyhexanoate, or any combinations thereof.

14. The method of claim 1, wherein the PHA polymer is poly(3-hydroxybutryate) (PHB), poly(3-hydroxybutryate-co-3-hydroxyvalerate) (PHBV), poly(4-hydroxybutyrate) (P4HB), poly(3-hydroxybutryate-co-4-hydroxybutyrate) (P3HB4HB), or poly(3-hydroxybutyrate-co-3-hydroxyhexanoate) P(3HB-co-3HHx).

15. The method of claim 1, further comprising:
forming a modified PHA article by processing the porous expanded PHA composite or the self-supporting porous PHA material,
wherein the processing includes coating, imbibing, laminating or any combination thereof, and
wherein the modified PHA article is porous or non-porous.

16. The method of claim 1, further comprising densifying the porous expanded PHA composite, the porous self-supporting porous PHA material, or the modified PHA article to form a densified PHA material;
wherein the densified PHA material comprises a detectable endotherm associated with the presence of the extended chain crystals of the PHA polymer: or
wherein the densifying includes the application of heat, the application of pressure, stretching or any combination thereof.

17.-18. (canceled)

19. The method of claim 1, wherein the PHA polymer further comprises at least one porogen prior to deposition on the substate;
wherein the method further comprises removing the porogen before or after expanding the PHA-substrate composite.

20. (canceled)

21. The method of claim 1, wherein the substrate is a deformable substrate, wherein the deformable substrate is an expandable polymer.

22. (canceled)

23. The method of claim 1, wherein the deformable substrate comprises a member selected from a polytetrafluoroethylene (PTFE) tape, a PTFE membrane, a polyolefin tape, a polyolefin membrane, an expanded polyolefin membrane, an ultra-high molecular weight polyethylene (UHMWPE) tape, an UHMWPE membrane, and an expanded UHMWPE membrane.

24. A porous polyhydroxyalkanoate (PHA) material formed from a PHA polymer, the porous PHA material having a microstructure comprising:
a plurality of nodes; and
a plurality of fibrils interconnecting the plurality of nodes, defining a fibril axis.

25. The porous PHA material of claim 24, wherein the fibrils comprise a plurality of extended chain crystals of the PHA polymer oriented along the fibril axis, wherein the extended chain crystals of the PHA polymer have a melting temperature higher than the Tₘ of the PHA polymer prior to expansion; or
wherein the PHA polymer has a molecular weight from 30,000 g/mol to 10,000,000 g/mol; or
wherein the porous PHA material has a porosity from 25% to 99%; or
wherein the porous PHA material is in the form of a membrane, a tube, a sheet, or a three-dimensional shape; or
wherein the porous PHA material has a matrix tensile strength of at least 5 MPa in a machine direction (MD) and/or a transverse direction (TD); or
wherein a total surface area of the porous PHA material per unit mass is greater than 20 m²/g.

26.-30. (canceled)

31. The porous PHA material of claim 24, wherein the PHA polymer is poly(3-hydroxybutryate) (PHB), poly(3-hydroxybutryate-co-3-hydroxyvalerate) (PHBV), poly(4-hydroxybutyrate) (P4HB), poly(3-hydroxybutryate-co-4-hydroxybutyrate), or poly(3-hydroxybutyrate-co-hydroxyhexanoate) P(HB-co-HHx).

32. (canceled)

33. The porous PHA material of claim 24, wherein the PHA polymer is blended with an additional polymer selected from polylactic acid (PLA), polybutylene adipate terephthalate (PBAT), polybutylene succinate (PBS), cellulose, polyglycolic acid (PGA), polycaprolactone (PCL), polyvinyl acetate (PVAc), chitin, chitosan, starch, and any combination thereof.

34. A composite comprising the porous PHA material of claim 24; wherein the PHA composite is microporous.

35. (canceled)

36. An article comprising the porous PHA material of claim 24, wherein the article comprises a woven or non-woven support substrate.

37. (canceled)

38. A material comprising a densified expanded polyhydroxyalkanoate having a detectable endotherm associated with the presence of residual extended chain crystals of the PHA polymer, wherein the material has a porosity less than 10%.

39. A porous polyhydroxyalkanoate (PHA) material formed from a PHA polymer of Formula I: 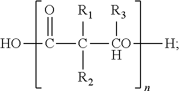 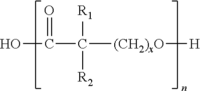
wherein R₁ and R₂ are independently H or C1 to C6 alkyl or aryl;
R₃ is C1 to C4 alkyl;
X is 2 to 4; and
n=3000 to 100,000; and
wherein the porous PHA material has a fibrillated microstructure comprising:
a plurality of nodes interconnected by fibrils or only fibrils, the fibrils having an orientation defining a fibril axis.

40.-56. (canceled)
